(19) United States
(12) Patent Application Publication
(10) Pub. No.: US 2013/0021517 A1
(43) Pub. Date: Jan. 24, 2013

(54) IMAGE PICKUP APPARATUS, SOLID-STATE IMAGE PICKUP ELEMENT, AND IMAGE PICKUP METHOD

(71) Applicants: Hiroki Ui, Tokyo (JP); Yutaka Nishimura, Kanagawa (JP); Shinichi Fujii, Kanagawa (JP)

(72) Inventors: Hiroki Ui, Tokyo (JP); Yutaka Nishimura, Kanagawa (JP); Shinichi Fujii, Kanagawa (JP)

(73) Assignee: SONY CORPORATION, Tokyo (JP)

(21) Appl. No.: 13/637,766

(22) PCT Filed: Apr. 1, 2011
(86) PCT No.: PCT/JP2011/058862

§ 371 Date: Sep. 27, 2012

(30) Foreign Application Priority Data
Apr. 8, 2010 (JP) 2010-089797

(51) Int. Cl. H04N 5/225; H04N 5/232

(52) U.S. Cl. 348/345; 348/360; 348/E05.024; 348/E05.045

(57) ABSTRACT

A solid-state image pickup device includes a first unit to convert light into an electrical signal and a second unit to convert light into an electrical signal. The first unit includes a first lens and a first pair of light receiving elements to receive light from the first lens. The second unit includes a second lens and a second pair of light receiving elements to receive light from the second lens. A profile of the second pair of light receiving elements is different in plan view than a profile of the first pair of light receiving elements.

### RELATED APPLICATION DATA

The present application claims priority to Japanese Patent Application JP 2010-089797, filed in the Japan Patent Office on Apr. 8, 2010, which is incorporated herein by reference in its entirety to the extent permitted by law.

The present invention relates to an image pickup apparatus and particularly relates to an image pickup apparatus that performs a phase difference detection, a solid-state image pickup element, an image pickup method, and a program that causes a computer to execute the method.

In recent years, an image pickup apparatus has been available such as a digital still camera that generates an picked-up image by picking up an image of a subject such as a person and records this generated picked-up image. Also, as this image pickup apparatus, to facilitate an image pickup operation by a user, an image pickup apparatus provided with an auto focus (AF: Auto Focus) function for automatically performing a focus (focus point, focal point) adjustment at the time of image pickup has been widely available.

For such an image pickup apparatus, for example, an image pickup apparatus that forms a pair of images by performing pupil division on light that passes through an image pickup lens and measures an interval between the formed images (detects a phase difference) to decide a position of the image pickup lens is proposed (for example, see PTL 1.). This image pickup apparatus forms a pair of image by providing an image sensor with a pixel for focus detection where a pair of light receiving elements are provided to one pixel and calculates a shift amount of the focus by measuring an interval between the formed images. Then, this image pickup apparatus calculates a movement amount of the image pickup lens on the basis of the calculated shift amount of the focus and adjusts the position of the image pickup lens on the basis of the calculated movement amount to effect focusing (focus adjustment).

### CITATION LIST

### Patent Literature

PTL 1: Japanese Unexamined Patent Application Publication No. 2000-305010 (FIG. 1)

According to the above-mentioned conventional technology, as both pixels including the pixel for phase difference detection (focus detection) and the pixel for picked-up image generation are provided to one image sensor, it is not necessary to separately provide two sensors of a sensor for focus detection and a sensor for picked-up image.

### SUMMARY OF THE INVENTION

However, regarding the above-mentioned conventional technology, the inventors have recognized that as the focus is detected in a state in which an aperture of the image pickup lens is opened, when the image pickup lens with a small F-number (bright image pickup lens) is used, a focus depth becomes shallow, and a situation may occur in which it is difficult to effect focusing in some cases.

Disclosed herein are one or more inventions that improve an accuracy of the focus adjustment.

For example, in one embodiment, a solid-state image pickup device includes a first unit to convert light into an electrical signal and a second unit to convert light into an electrical signal. The first unit includes a first lens and a first pair of light receiving elements to receive light from the first lens. The second unit includes a second lens, and a second pair of light receiving elements to receive light from the second lens. A profile of the second pair of light receiving elements is different in plan view than a profile of the first pair of light receiving elements.

In an embodiment, an image pickup apparatus includes a first unit to convert light into an electrical signal, a second unit to convert light into an electrical signal, and a signal processing unit to process electric signals from the first pair of light receiving elements and the second pair of light receiving elements. The first unit includes (a) a first lens and (b) a first pair of light receiving elements to receive light from the first lens. The second unit includes (a) a second lens and (b) a second pair of light receiving elements to receive light from the second lens. A profile of the second pair of light receiving elements is different in plan view than a profile of the first pair of light receiving elements.

In an embodiment, a method for controlling an image pickup apparatus includes (a) receiving electric signals from a first pair of light receiving elements of an image sensor, (b) receiving electric signals from a second pair of light receiving elements of the image sensor, and (c) processing electric signals from the first pair of light receiving elements and the second pair of light receiving elements. A profile of the second pair of light receiving elements is different in plan view than a profile of the first pair of light receiving elements.

### BRIEF DESCRIPTION OF DRAWINGS

FIG. 1 is a block diagram illustrating a configuration example of an image pickup apparatus according to a first embodiment.

FIG. 2A is a cross sectional view and FIG. 2B is a top view that schematically illustrate an example of an image pickup element that is the same pixel as an existing image pickup element.

FIGS. 3A and 3B are schematic diagrams illustrating an example of a focus detection pixel according to the first embodiment.

FIGS. 4A and 4B are top views schematically illustrating focus detection pixels according to the first embodiment.

FIG. 5 is a top view schematically illustrating a focus detection pixel according to the first embodiment.

FIG. 6A is a cross sectional view and FIG. 6B is a top view schematically illustrating an example of a focus detection pixel.

FIGS. 7A and 7B are top views schematically illustrating focus detection pixels according to the first embodiment.

FIG. 8 is a top view schematically illustrating a focus detection pixel according to the first embodiment.

FIG. 9 is a schematic diagram illustrating an example of an area where the focus detection pixels and focus detection pixels according to the first embodiment.

FIG. 10 is a schematic diagram illustrating an example of a pixel arrangement in a focus detection area according to the first embodiment

FIG. 11 is a schematic diagram illustrating an example of a pixel arrangement in a focus detection area according to the first embodiment.

FIG. 12 is a schematic diagram illustrating focus detection characteristics of the focus detection pixels and the focus detection pixels according to the first embodiment.

FIG. 13 illustrates a phase difference detection example in a case where a shift of a focus is large.

FIG. 14 illustrates a phase difference detection example in a case where after the focus is adjusted by using the focus detection pixel, the focus is finely adjusted by using the focus detection pixel.

FIG. 15 illustrates a phase difference detection example in a case where the shift of the focus is small.

FIG. 16 is a flow chart illustrating a focus control procedure example by the image pickup apparatus according to the first embodiment.

FIG. 17A is a cross sectional view and FIG. 17B is a top view schematically illustrating an example of another focus detection pixel usable in a second embodiment.

FIGS. 18A and 18B are top views schematically illustrating focus detection pixels usable in the second embodiment.

FIG. 19 is a top view schematically illustrating a focus detection pixel usable in the second embodiment.

FIG. 20 is a schematic diagram illustrating an example of a pixel arrangement in a focus detection area usable in the second embodiment.

FIG. 21 is a schematic diagram illustrating an example of a pixel arrangement in a focus detection area according to the second embodiment.

FIG. 22 illustrates a phase difference detection example in a case where the shift of the focus is large.

FIG. 23 illustrates a phase difference detection example in a case where the shift of the focus is small.

FIGS. 24A and 24B are schematic diagrams illustrating examples of signal lines of the image sensor usable in a third embodiment.

### DESCRIPTION OF THE PRESENTLY PREFERRED EMBODIMENTS

Hereinafter, devices and constructions embodying principles of the present invention(s) (herein referred to as embodiments) will be described. The description will be carried out in the following order.

1. First Embodiment (image pickup control: an example of providing a focus detection pixel provided with a narrow rectangular light receiving element and a focus detection pixel provided with a thick rectangular light receiving element)

2. Second Embodiment (image pickup control: an example of providing two focus detection pixels provided with a narrow rectangular light receiving element at different positions)

3. Third Embodiment (image pickup control: an example of arranging two signal lines)

### 1. First Embodiment

### Functional Configuration Example of Image Pickup Apparatus

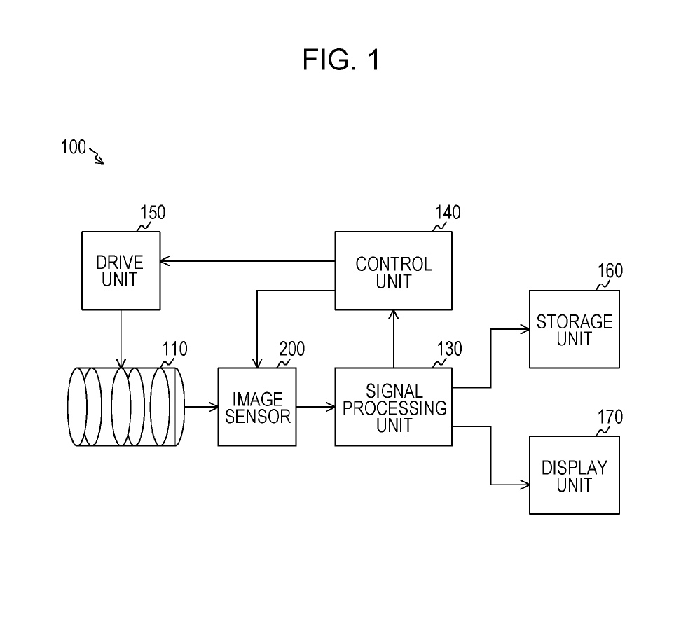

FIG. 1 is a block diagram illustrating a configuration example of an image pickup apparatus 100 according to a first embodiment. This image pickup apparatus 100 is provided with a lens unit 110, an image sensor 200, a signal processing unit 130, a control unit 140, a drive unit 150, a storage unit 160, and a display unit 170.

It should be noted that this image pickup apparatus 100 is configured to perform an AF (Auto Focus) control based on a phase difference detection system. This phase difference detection system is a system in which an image interval of subjects separated by two lenses is measured, and a position of an image pickup lens is decided on the basis of the position where this image interval becomes a predetermined value. Also, in a case where the focus is detected by the AF, it is supposed that this image pickup apparatus 100 performs the focus detection while an aperture in the lens unit 110 is kept in an opened state (for example, in the case of a lens whose open F-number is “1.4”, a setting of the F-number is “1.4”).

The lens unit 110 is composed of a plurality of image pickup lenses such as a focus lens and a zoom lens and is configured to supply incident light from a subject which is input via these lenses to the image sensor 200. This lens unit 110 is adjusted so that the focus (which is also referred to as focus point or focal point) with respect to the subject is effected while positions of the plurality of image pickup lenses are adjusted by the drive unit 150. Also, this lens unit 110 is provided with an aperture for adjusting a light amount and adjusts the light amount at the time of picking up an image of the subject by closing this aperture.

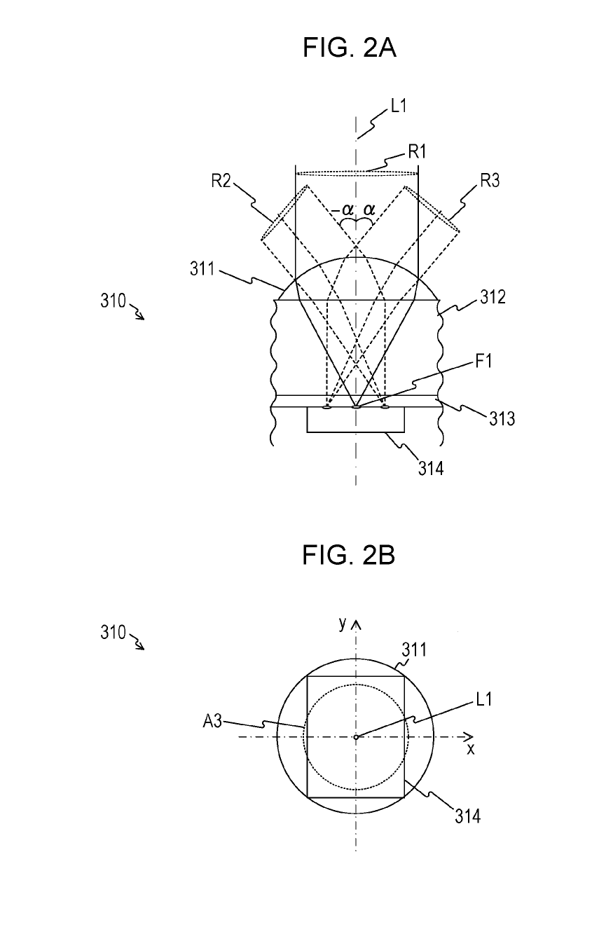

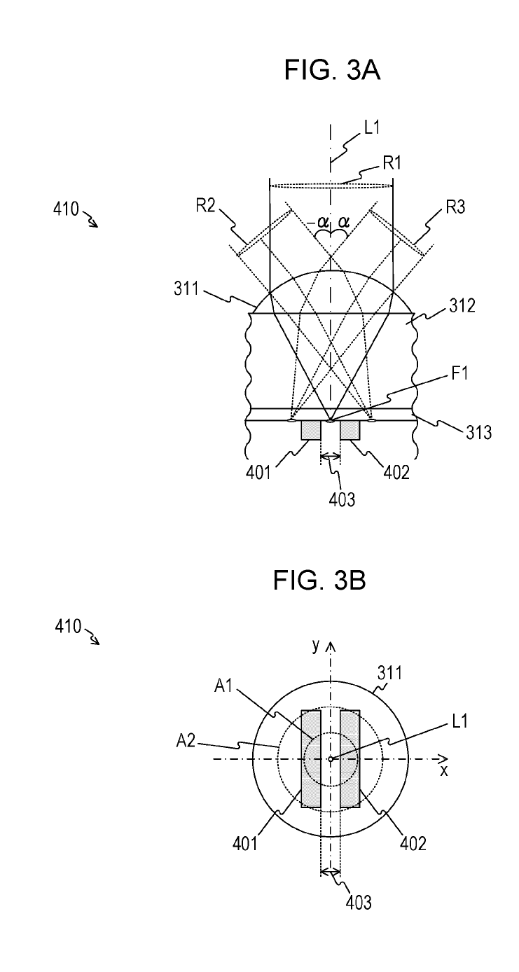

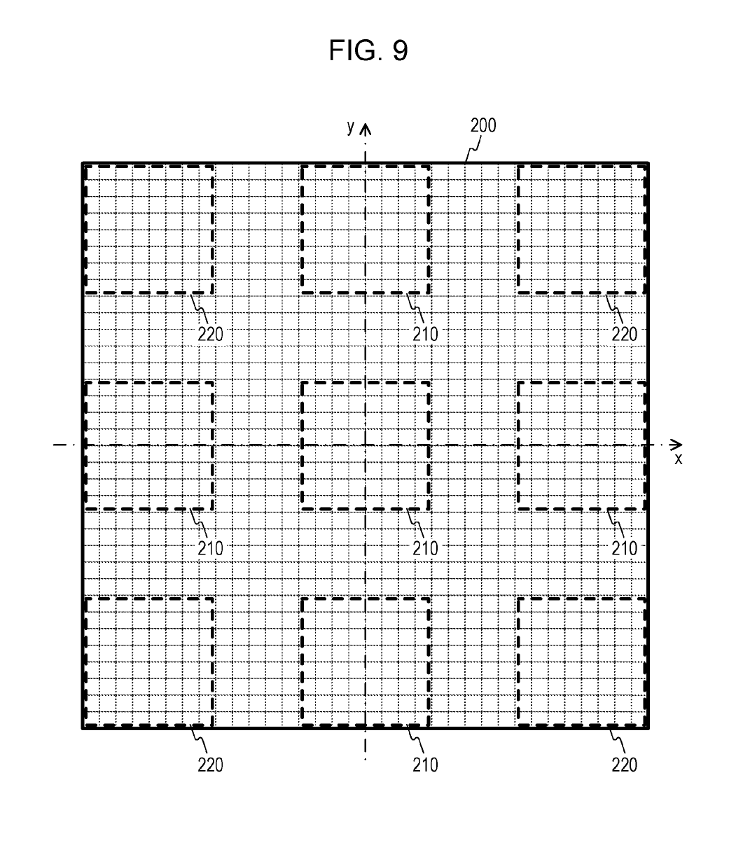

The image sensor 200 is an image pickup element that performs photoelectric conversion on the incident light from the subject passing through the lens unit 110 on the basis of a control by the control unit 140 into an electric signal. This image sensor 200 is composed of a pixel that generates an electric signal (image pickup signal) for generating a picked-up image and a pixel that generates an electric signal (focus adjustment signal) for adjusting the focus. This image sensor 200 supplies the electric signal generated through the photoelectric conversion to the signal processing unit 130. It should be noted that the image sensor 200 is supposed to have a substantially rectangular shape. Also, the pixel that generates the image pickup signal (image pickup pixel) will be described in detail by using FIGS. 2A and 2B. Also, the pixel that generates the focus adjustment signal (focus detection pixel) will be described in detail by using FIGS. 3 to 8. Also, this image sensor 200 will be described in detail by using FIGS. 9 to 11. It should be noted that the image sensor 200 is an example of an image pickup element described in the scope of claims. Also, the focus adjustment signal is an example of a focus detection signal described in the scope of claims.

The signal processing unit 130 is configured to apply various signal processings on the electric signal supplied from the image sensor 200. For example, this signal processing unit 130 generates picked-up image data on the basis of the image pickup signal supplied from the image sensor 200 and supplies this generated picked-up image data to the storage unit 160 to be recorded in the storage unit 160 as the image file. Also, the signal processing unit 130 supplies the generated picked-up image data to the display unit 170 to be displayed as the picked-up image. Also, this signal processing unit 130 generates image data for focus adjustment on the basis of the focus adjustment signal supplied from the image sensor 200 and supplies this generated image data for focus adjustment to the control unit 140.

The control unit 140 is configured to calculate a shift amount of the focus (defocus amount) on the basis of the image data for focus adjustment supplied from the signal processing unit 130 and calculate a movement amount of the image pickup lens of the lens unit 110 on the basis of the calculated defocus amount. Then, this control unit 140 supplies information related to the calculated movement amount of the image pickup lens to the drive unit 150. That is, this control unit 140 performs an in-focus determination by calculating the shift amount of the focus, generates information related to the movement amount of the image pickup lens on the basis of this in-focus determination result, and supplies this generated information to the drive unit 150. It should be noted that the control unit 140 is an example of a determination unit described in the scope of claims.

The drive unit 150 is configured to move the image pickup lens of the lens unit 110 on the basis of the information related to the movement amount of the image pickup lens supplied from the control unit 140.

The storage unit 160 is configured to store the picked-up image data supplied from the signal processing unit 130 as an image file.

The display unit 170 is configured to display the picked-up image data supplied from the signal processing unit 130 as a picked-up image (for example, a through-the-lens image).

### [Configuration Example of Image Pickup Pixel]

FIG. 2A is a cross sectional view and FIG. 2B is a top view schematically illustrating an example of an image pickup pixel 310 that is the same pixel as an existing image pickup pixel. The image pickup pixel 310 illustrated in FIGS. 2A and 2B illustrate an example of a pixel (image pickup pixel) that generates an image pickup signal among the respective pixels constituting the image sensor 200.

FIG. 2A schematically illustrates a cross sectional configuration of the image pickup pixel 310 in the image sensor 200.

This image pickup pixel 310 is provided with a planarizing film 312, an insulating film 313, and a light receiving element 314. Also, a micro lens 311 that condenses light incident on the image pickup pixel 310 to the light receiving element 314 is provided on the image pickup pixel 310.

It should be noted that herein, the light passing through the micro lens 311 is in focus on a light receiving plane of the light receiving element 314.

The micro lens 311 is arranged so that the center of the micro lens 311 and the center of the light receiving element 314 are located on a same axis. Also, this micro lens 311 is arranged so that a light receiving position of the light receiving element 314 and a position of a focus F1 of the micro lens 311 are on a same plane.

The planarizing film 312 and the insulating film 313 are layers composed of a transparent insulating material which cover the light receiving plane of the light receiving element 314. It should be noted that a color filter of red, green, or blue is arranged between the planarizing film 312 and the insulating film 313 in an actual apparatus, but according to the first embodiment, for the sake of simplicity in the description, the image sensor 200 that detects monochrome (brightness of light) is supposed.

The light receiving element 314 is configured to generate an electric signal at an intensity in accordance with the amount of the received light by converting the received light into the electric signal (photoelectric conversion). This light receiving element 314 is composed, for example, of a photo diode (PD: Photo Diode).

Herein, the light incident on the light receiving element 314 (incident light) will be described by using FIG. 2(a). FIG. 2A schematically illustrates light incident on the micro lens 311 at an angle in parallel to an axis L1 which is parallel to the optical axis passing through the center position of the micro lens 311 (light irradiated in a range R1 illustrated in FIG. 2A) among the light incident on the light receiving element 314. Also, FIG. 2A schematically illustrates light incident on the micro lens 311 (light incident in ranges R2 and R3 illustrated in FIG. 2A) at an angle inclined by predetermined angles with respect to the axis L1 (angles −α and α illustrated in FIG. 2A). It should be noted that the axis L1 is an example of an optical axis of the micro lens described in the scope of claims.

The light incident in the range R1 (range R1 incident light) is light incident on the micro lens 311 at an angle in parallel to the axis L1. This range R1 incident light is condensed by the micro lens 311 at the focus F1.

The lights incident in the ranges R2 and R3 (the range R2 incident light and the range R3 incident light) are lights incident on the micro lens 311 at an angle inclined by predetermined angles (−α and α) with respect to the axis L1. These range R2 incident light and range R3 incident light are incident lights illustrating examples of light incident on the micro lens 311 at an angle inclined by predetermined angles with respect to the axis L1. These range R2 incident light and range R3 incident light are condensed in a predetermined area in the light receiving plane of the light receiving element 314.

FIG. 2B illustrates an example of an irradiation position of the light incident on the image pickup pixel 310 illustrated in FIG. 2A.

It should be noted that in FIG. 2B, a description will be given while an xy coordinate system is supposed in which an intersecting point of the axis L1 parallel in an optical axis direction passing through the center position of the micro lens 311 and the light receiving plane of the light receiving element 314 is set as an origin, a long side in the image sensor 200 is set as an x axis, and a narrow side thereof is set as the y axis. Also, similarly also with respect to an xy coordinate system which will be described below, a description will be given while the xy coordinate system is supposed in which the intersecting point of the axis parallel to the optical axis passing through the center position of the micro lens and the light receiving plane of the light receiving element is set as the origin, the long side in the image sensor 200 is set as the x axis, and the narrow side thereof is set as the y axis.

In this FIG. 2B, components other than a light distribution area A3 are the same as those illustrated in FIG. 2A, the same reference symbols as those of FIG. 2A are assigned, and a description herein will be omitted.

The light distribution area A3 is an area where the light receiving plane of the light receiving element 314 is irradiated with the incident light on the micro lens 311. As illustrated in FIG. 2A, the light irradiated with this light distribution area A3 (irradiation light) becomes light having a larger incident angle on the micro lens 311 as being away from the axis L1.

Herein, the irradiation light in the light distribution area A3 will be described. The irradiation light in the vicinity of the center of the light receiving element 314 (in the vicinity of the axis L1) is irradiated light passing through the center of the image pickup lens. That is, this irradiation light is light to be irradiated similarly to the case of the opened state even when the aperture is being closed as the light passing through the center of the image pickup lens to be irradiated is not interrupted even when the aperture in the lens unit 110 (for example, the F-number approximately “5.6” is supposed) is being closed.

On the other hand, the irradiation light at a location away from the center of the light receiving element 314 is light passing through a location away from the center of the image pickup lens to be irradiated. That is, this irradiation light is light where the irradiation is interrupted as the light passing through the location away from the center of the image pickup lens is interrupted by the aperture when the aperture in the lens unit 110 is being closed.

### [Configuration Example of Focus Detection Pixel]

FIGS. 3A and 3B are schematic diagrams illustrating an example of a focus detection pixel 410 according to the first embodiment.

It should be noted that according to the first embodiment, it is supposed that the micro lens 311 in the focus detection pixel 410 is identical to the micro lens 311 of the image pickup pixel 310 illustrated in FIGS. 2A and 2B.

Also, according to the first embodiment, it is set that the size of the entire pixel of the focus detection pixel 410 is the same size as the image pickup pixel 310 illustrated in FIGS. 2A and 2B. Also, according to the first embodiment, it is set that the center of the focus detection pixel 410 and the axis L1 are located on the same axis.

FIG. 3A schematically illustrates a cross sectional configuration of the focus detection pixel 410. FIG. 3A illustrates a cross sectional configuration in a case where the left and right direction of FIG. 3A is set as a narrow side direction of the light receiving element in the focus detection pixel 410.

It should be noted that in this FIG. 3A, as configurations other than a first light receiving element 401, a second light receiving element 402, and an element separation area 403 are identical to the respective configurations of the image pickup pixel 310 illustrated in FIG. 2A, the same reference symbols as those of FIG. 2A are assigned, and a description herein will be omitted. Also, the incident light on the focus detection pixel 410 is similar to that of FIG. 2A, and a description herein will thus be omitted.

The first light receiving element 401 is a light receiving element that forms a pair with the second light receiving element 402 and is arranged to receive light at a small angle with respect to the axis L1 among one light of the incident lights subjected to the pupil division. That is, this first light receiving element 401 receives the light passing in the vicinity of the center of the image pickup lens (light to be irradiated similarly to the case of the opened state even when the aperture is being closed). This first light receiving element 401 has, for example, a narrow rectangular shape and is located at a position close to the axis L1 and at a position where the range R3 irradiation light is not irradiated. This first light receiving element 401 generates a current at an intensity in accordance with the amount of the received light by converting the received light into the current (photoelectric conversion) similarly as in the light receiving element 314 illustrated in FIG. 2A.

The second light receiving element 402 is a light receiving element that forms a pair with the first light receiving element 401 and is arranged to receive the other incident light subjected to the pupil division that is different from the light received by the first light receiving element 401. This second light receiving element 402 is the same receiving light element as the first light receiving element 401 in terms of the size and the performance. A function of this second light receiving element 402 is similar to the function of the first light receiving element 401, and a description herein will thus be omitted.

The element separation area 403 is an insulating area located between the first light receiving element 401 and the second light receiving element 402 and is an area for separating the first light receiving element 401 and the second light receiving element 402 so as not to contact with each other. This element separation area 403 is structured between the first light receiving element 401 and the second light receiving element 402 so that the first light receiving element 401 and the second light receiving element 402 are located in parallel to each other. Also, this element separation area 403 is structured so that the first light receiving element 401 and the second light receiving element 402 are located at an equal distance from the axis L1. For example, while a plane including the axis L1 is set as a symmetry plane, the element separation area 403 is structured so that the first light receiving element 401 and the second light receiving element 402 are symmetric to each other.

That is, in the focus detection pixel 410, the axis L1 is located in the center of the element separation area 403. Also, as the center of the focus detection pixel 410 coincides with the axis L1, the first light receiving element 401 and the second light receiving element 402 are structured to be located at an equal distance from the center of the focus detection pixel 410.

It should be noted that according to the first embodiment, an interval between the first light receiving element 401 and the second light receiving element 402 by this element separation area 403 is set as a narrowest interval so that the first light receiving element 401 and the second light receiving element 402 can be created so as not to contact with each other when the focus detection pixel is created.

FIG. 3B illustrates an irradiation position example of the light incident on the focus detection pixel 410 illustrated in FIG. 3A.

It should be noted that as components other than a light distribution area A1 and a light distribution area A2 are similar to those illustrated in FIG. 2B and FIG. 3A, the same reference symbols are assigned, and a description herein will be omitted.

The light distribution area A1 is an area where light at a small angle with reference to the axis L1 (non-telecentric light close to parallel rays of light (telecentric light)) is irradiated. For example, this light distribution area A1 is an area where the incident light from the lens unit 110 with the setting of the F-number “5.6” is irradiated. Also, this light distribution area A1 indicates an irradiation area of the light equivalent to the F-number “5.6” in a case where the lens unit 110 has the setting of the F-number “1.4”, among the light irradiated with the focus plane of the focus detection pixel 410.

The light distribution area A2 is an area on an outer-side of the light distribution area A1 and indicates an irradiation area where light incident on the micro lens 311 at a larger incident angle than the irradiation light in the light distribution area A1 (non-telecentric light having a largely different angle from the parallel rays of light) is irradiated. For example, this light distribution area A2 is an area where the incident light from the lens unit 110 with the setting of the F-number “5.6” is not irradiated. Also, this light distribution area A1 indicates an irradiation area of the light except for the irradiation light at the time of the F-number “5.6” in a case where the lens unit 110 has the setting of the F-number “1.4”, among the light irradiated with the focus plane of the focus detection pixel 410.

As illustrated in these FIGS. 3A and 3B, the first light receiving element 401 and the second light receiving element 402 of the focus detection pixel 410 receive the light irradiated with the area close to the axis L1 (the light distribution area A1) (light at a small angle with respect to the axis L1). These first light receiving element 401 and second light receiving element 402 cannot receive the light irradiated with the element separation area 403 but receive much of the irradiation light at the time of the F-number “5.6” and output a focus adjustment electric signal in accordance with the intensity of the received light.

In this manner, the focus detection pixel 410 receives the light equivalent to the F-number “5.6” among the light incident on the focus detection pixel 410 (setting of the F-number is “1.4”) in a case where the focus is detected by the AF.

It should be noted that in these FIGS. 3A and 3B, the description has been given in which the shape of the first light receiving element 401 and the second light receiving element 402 is the narrow rectangular, but the present invention is not limited to this. These first light receiving element 401 and second light receiving element 402 may have a shape with which it is possible to receive the light irradiated with the area close to the axis L1 (for example, the light distribution area A1). For that reason, for example, a small rectangular, a semicircle, or the like, is conceivable which is closer to the shape of the light distribution area A1 than the first light receiving element 401 and the second light receiving element 402 illustrated in FIGS. 3A and 3B.

### [Light Receiving Example of Focus Detection Pixels 420 to 440]

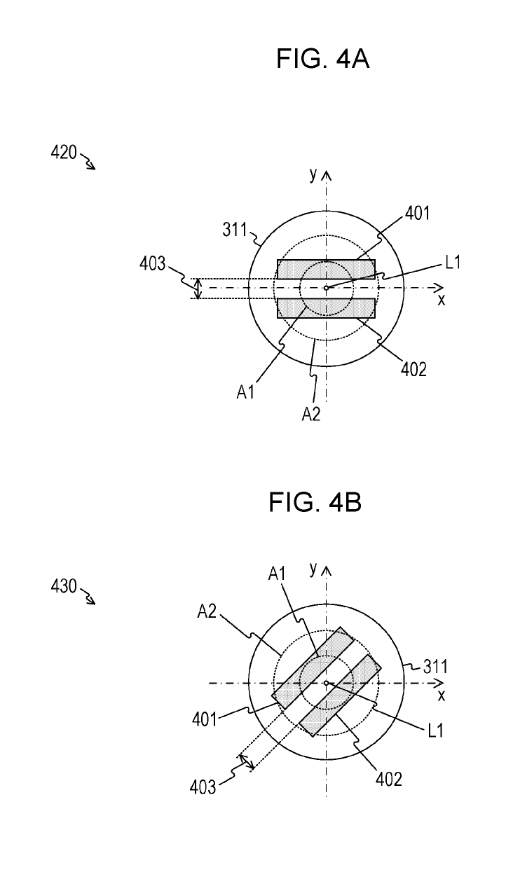

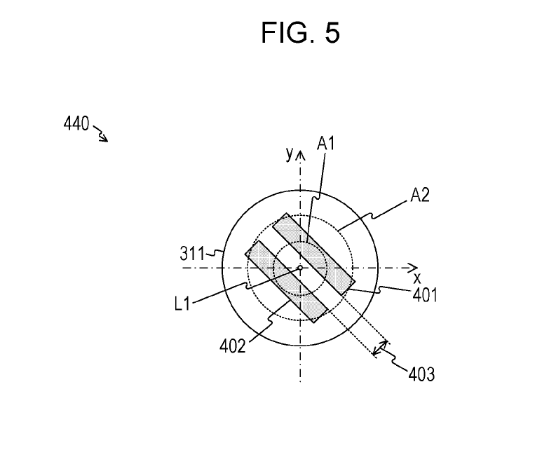

FIGS. 4A, 4B, and 5 are schematic diagrams illustrating light receiving examples of light incident on focus detection pixels 420 to 440 according to the first embodiment.

In FIGS. 4A, 4B, and 5, with regard to the focus detection pixels 420 to 440, a difference from the focus detection pixel 410 illustrated in FIG. 3B will be described. It should be noted that cross sectional configurations of the focus detection pixels 420 to 440 are the same as cross sectional configuration of the focus detection pixel 410 illustrated in FIG. 3A, and a description herein will be omitted.

FIGS. 4A and 4B are top views schematically illustrating the focus detection pixels 420 and 430 according to the first embodiment.

As illustrated in FIG. 4A, while the origin of the xy coordinate system is set as the rotation center, the focus detection pixel 420 is obtained by rotating clockwise the focus detection pixel 410 illustrated in FIG. 4A by 90°. This focus detection pixel 420 can receive the irradiation light equivalent to the irradiation light at the time of the F-number “5.6” among the lights subjected to the pupil division in the up and down direction of the micro lens 311 (positive and negative on the y axis).

As illustrated in FIG. 4B, while the origin of the xy coordinate system is set as the rotation center, the focus detection pixel 430 is obtained by rotating clockwise the focus detection pixel 410 illustrated in FIG. 4A by 315°. This focus detection pixel 430 can receive light equivalent to the irradiation light at the time of the F-number “5.6” among the lights subjected to the pupil division in the direction of the upper left and the lower right of the micro lens 311 (divided by the line of y=x).

FIG. 5 is a top view schematically illustrating the focus detection pixel 440 according to the first embodiment.

While the origin of the xy coordinate system is set as the rotation center, the focus detection pixel 440 is obtained by rotating clockwise the focus detection pixel 410 illustrated in FIG. 4A by 225°. This focus detection pixel 440 can receive light equivalent to the irradiation light at the time of the F-number “5.6” among the lights subjected to the pupil division in the direction of the lower left and the upper right of the micro lens 311 (divided by the line of y=−x).

In this manner, in the focus detection pixels 410 to 440 illustrated in FIGS. 3 to 5, among the irradiation light at the F-number “1.4” that is incident on the focus detection pixel, light equivalent to the irradiation light at the time of the F-number “5.6” (a state in which the aperture of the lens unit 110 is being closed) can be received by a pair of light receiving elements. According to this, the control unit 140 can adjust the focus on the basis of the irradiation light at the F-number “5.6”.

It should be noted that herein, the light receiving plane of the light receiving element is aligned with the focus plane, but the present invention is not limited to this. To precisely separate the incident light on the micro lens 311, the light receiving plane of the light receiving element may also be at the rear of the focus plane.

### [Configuration Example of Focus Detection Pixel]

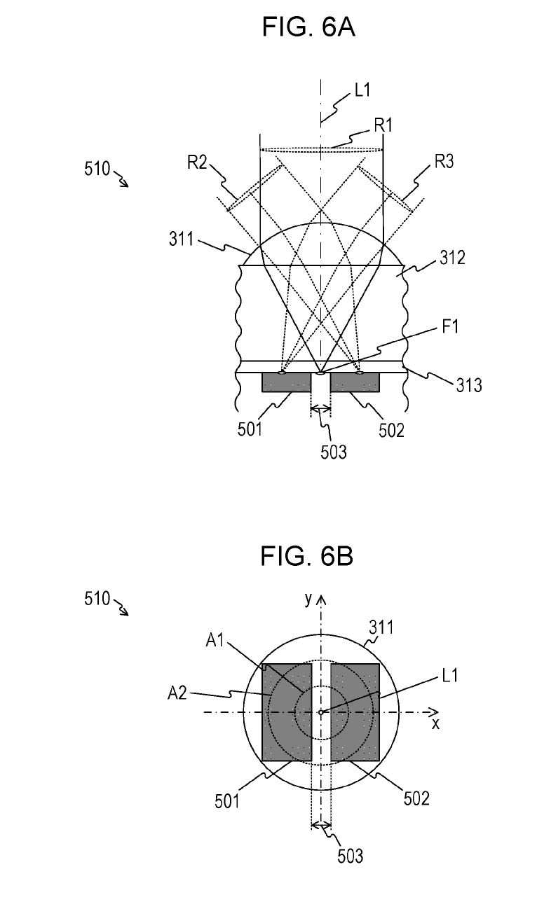

FIG. 6A is a cross sectional view and FIG. 6B is a top view schematically illustrating an example of the focus detection pixel 510 that is the same pixel as an existing focus detection pixel.

It should be noted that according to the first embodiment, the micro lens 311 in the focus detection pixel 510 is set to be the same as the micro lens 311 of the image pickup pixel 310 illustrated in FIGS. 2A and 2B. Also, according to the first embodiment, it is set that the size of the entire pixel of the focus detection pixel 510 is the same size as the image pickup pixel 310 illustrated in FIGS. 2A and 2B. Also, according to the first embodiment, it is set that the center of the focus detection pixel 510 and the axis L1 are located on the same axis.

FIG. 6A schematically illustrates a cross sectional configuration of the focus detection pixel 510. FIG. 6A illustrates a cross sectional configuration in a case where the left and right direction of FIG. 6A is set as the narrow side direction of the light receiving element in the focus detection pixel 510.

It should be noted that in this FIG. 6A, as configurations other than a first light receiving element 501, a second light receiving element 502, and an element separation area 503 are identical to the respective configurations of the image pickup pixel 310 illustrated in FIG. 2A, the same reference symbols as those of FIG. 2A are assigned, and a description herein will be omitted. Also, incident light on the focus detection pixel 510 is similar to that of FIG. 2A, and a description herein will thus be omitted.

The first light receiving element 501 is a light receiving element that forms a pair with the second light receiving element 502 and is arranged to receive the most part of one light of the incident lights subjected to the pupil division. That is, this first light receiving element 501 receives both lights including the light passing in the vicinity of the center of the image pickup lens and the light passing through a location away from the center of the image pickup lens (light interrupted when the aperture is being closed). This first light receiving element 501 is composed, for example, of a large-sized rectangular light receiving element that receives the most part of the light incident on the micro lens 311 from the right side of the axis L1 illustrated in these FIGS. 3A and 3B. That is, the shape of this first light receiving element 501 is a thicker rectangular than the first light receiving element 401 of the focus detection pixel 410 illustrated in FIGS. 3A and 3B. This first light receiving element 401 generates a current at an intensity in accordance with the amount of the received light by converting the received light into the current (photoelectric conversion) similarly as in the light receiving element 314 illustrated in FIG. 2A.

The second light receiving element 502 is a light receiving element that forms a pair with the first light receiving element 501 and is arranged to receive the other incident light subjected to the pupil division that is different from the light received by the first light receiving element 501. This second light receiving element 402 is the same receiving light element as the first light receiving element 501 in terms of the size and the performance. A function of this second light receiving element 502 is similar to the function of the first light receiving element 501, and a description herein will thus be omitted.

The element separation area 503 is an insulating area located between the first light receiving element 401 and the second light receiving element 402 similarly as in the element separation area 403 illustrated in FIGS. 3A and 3B. This element separation area 503 is similar to the element separation area 403, and a description herein will thus be omitted.

FIG. 6B illustrates an irradiation position example of the light incident on the focus detection pixel 510 illustrated in FIG. 6A.

Here, a difference between an irradiation position in the focus detection pixel 510 and an irradiation position in the focus detection pixel 410 illustrated in FIG. 3B will be described.

As illustrated in this FIG. 6B, the first light receiving element 501 of the focus detection pixel 510 can receive the most of the light irradiated with the left side of the light distribution areas A1 and A2 (on the focus plane, the minus side in the x axis direction with respect to the axis L1). Similarly, the second light receiving element 502 can receive the most of the light irradiated with the right side of the light distribution areas A1 and A2 (on the focus plane, the plus side in the x axis direction with respect to the axis L1).

As illustrated in these FIGS. 6A and 6B, the first light receiving element 501 and the second light receiving element 502 of the focus detection pixel 510 receive both lights including the light irradiated with the area close to the axis L1 (the light distribution area A1) and the light irradiated with the area far from the axis L1 (the light distribution area A2). That is, in a case where the focus is detected by the AF, the focus detection pixel 510 receives most of the light among the light incident on the focus detection pixel 410 (setting of the F-number is “1.4”).

In this manner, the focus detection pixel 510 is different only in the same of the light receiving element as compared with the focus detection pixel 410. That is, in the focus detection pixel 510, the distance between the end portions on the axis L1 side of one pair of the light receiving elements (width of the element separation area 503) is the same as the distance between the end portions on the axis L1 side of one pair of the light receiving elements of the focus detection pixel 410 (width of the element separation area 403). Also, in the focus detection pixel 510, the distance between the end portions on the outer-side with respect to the axis L1 of one pair of the light receiving elements (total of widths of one pair of the light receiving elements and the element separation area 503) is larger than the distance between the end portions on the outer-side with respect to the axis L1 of one pair of the light receiving elements of the focus detection pixel 410.

It should be noted that for the light received by the focus detection pixel 510, the light equivalent to the F-number “1.4” has been set as the example, but the present invention is not limited to this. An F-number including light at a larger irradiation angle than the light received by the focus detection pixel 410 suffices. That is, as compared with the light received by the focus detection pixel 410, a smaller F-number suffices. Also, similarly, the focus detection pixel 410 is not limited to the light equivalent to the F-number “5.6”, and as compared with the light received by the focus detection pixel 510, a larger F-number suffices.

### [Light Receiving Example of Focus Detection Pixels 520 to 540]

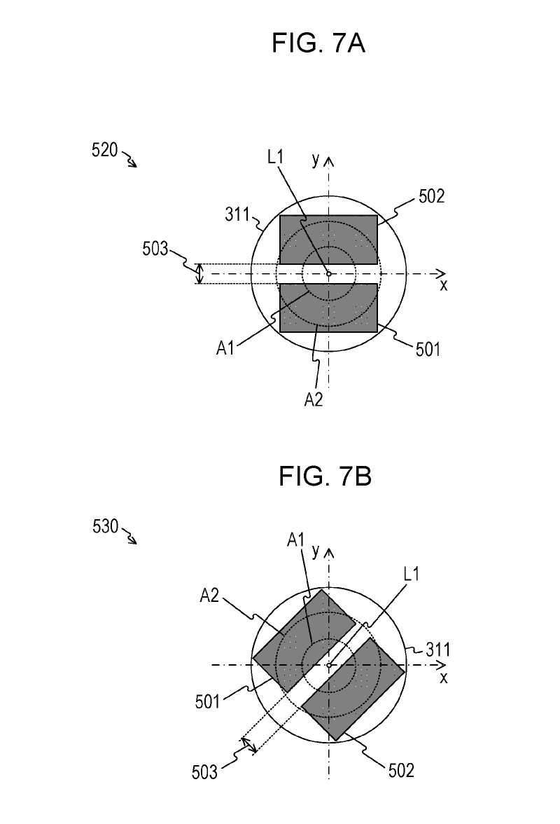

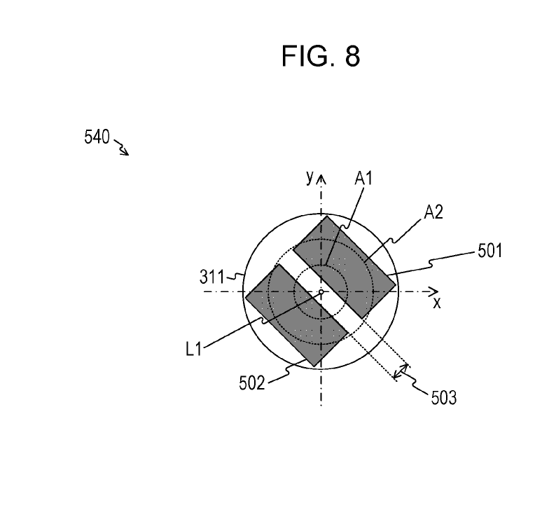

FIGS. 7A, 7B, and 8 are schematic diagrams illustrating light receiving examples of light incident on focus detection pixels 520 to 540 according to the first embodiment.

FIGS. 7A, 7B, and 8 describe with regard to the focus detection pixels 520 to 540 on a difference from the focus detection pixel 510 illustrated in FIG. 6B. It should be noted that cross sectional configurations of the focus detection pixels 520 to 540 are the same as the cross sectional configuration of the focus detection pixel 510 illustrated in FIG. 6A, and a description herein will thus be omitted.

FIGS. 7A and 7B are top views schematically illustrating the focus detection pixels 520 and 530 according to the first embodiment.

As illustrated in FIG. 7A, while the origin of the xy coordinate system is set as the rotation center, the focal detection pixel 520 is obtained by rotating clockwise the focus detection pixel 510 illustrated in FIG. 6A by 90°. This focal detection pixel 520 can receive most of the irradiation light among the lights subjected to the pupil division in the up and down direction the micro lens 311 (positive and negative on the y axis).

As illustrated in FIG. 7B, while the origin of the xy coordinate system is set as the rotation center, the focal detection pixel 530 is obtained by rotating clockwise the focus detection pixel 510 illustrated in FIG. 6A by 315°. This focal detection pixel 530 can receive most of the irradiation light among the lights subjected to the pupil division in the direction of the upper left and the lower right of the micro lens 311 (divided by the line of y=x).

FIG. 8 is a top view schematically illustrating the focal detection pixel 540 according to the first embodiment.

While the origin of the xy coordinate system is set as the rotation center, the focal detection pixel 540 is obtained by rotating clockwise the focus detection pixel 510 illustrated in FIG. 6A by 225°. This focal detection pixel 540 can receive most of the irradiation light among the lights subjected to the pupil division in the direction of the lower left and the upper right of the micro lens 311 (divided by the line of y=−x).

In this manner, in the focus detection pixels 510 to 540 illustrated in FIGS. 6 to 8, most of the irradiation light among the irradiation light at the F-number “1.4” that is incident on the focus detection pixel can be received by one pair of the light receiving elements. According to this, the control unit 140 can adjust the focus on the basis of the irradiation light at the F-number “1.4” (open F-number).

### [Arrangement Example of Focus Detection Pixels in Image Sensor]

FIG. 9 is a schematic diagram illustrating examples of areas where the focus detection pixels 410 to 440 and the focus detection pixels 510 to 540 are arranged in the image sensor 200 according to the first embodiment.

This FIG. 9 illustrates the image sensor 200 and focus detection areas 210 and 220. It should be noted that in this FIG. 9, a description will be given while xy axes are supposed in which the left and right direction is set as the x axis and the up and down direction is set as the y axis while the center of the image sensor 200 is set as an origin.

The focus detection areas 210 and 220 are areas indicating an example of an area where the focus detection pixels 410 to 440 and the focus detection pixels 510 to 540 are arranged. In this focus detection area, the image pickup pixel 310 and any of the focus detection pixels 410 to 440, and the focus detection pixels 510 to 540 are arranged in a predetermined pattern. Also, in an area other than the focus detection area of the image sensor 200, only the image pickup pixel 310 is arranged.

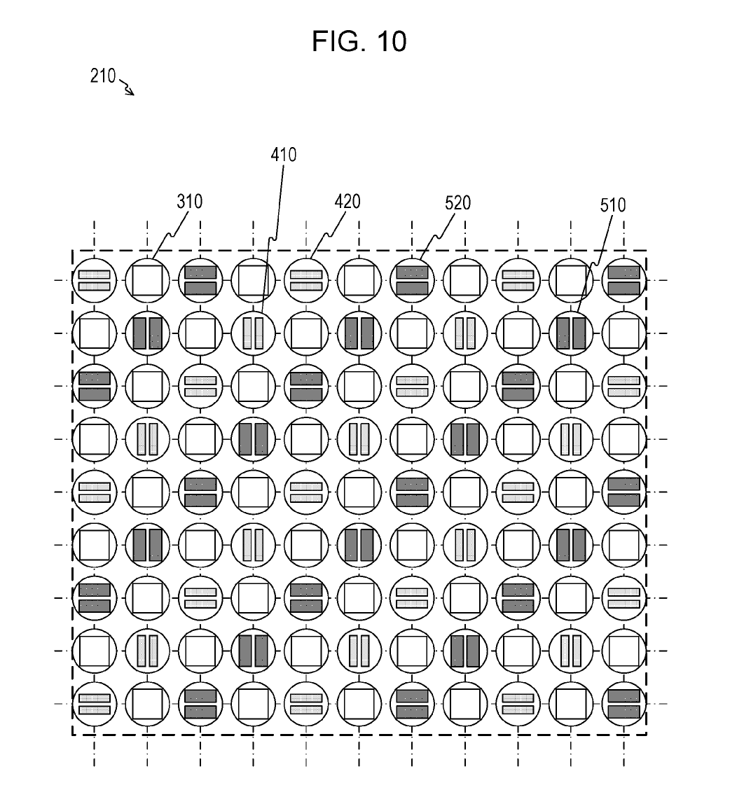

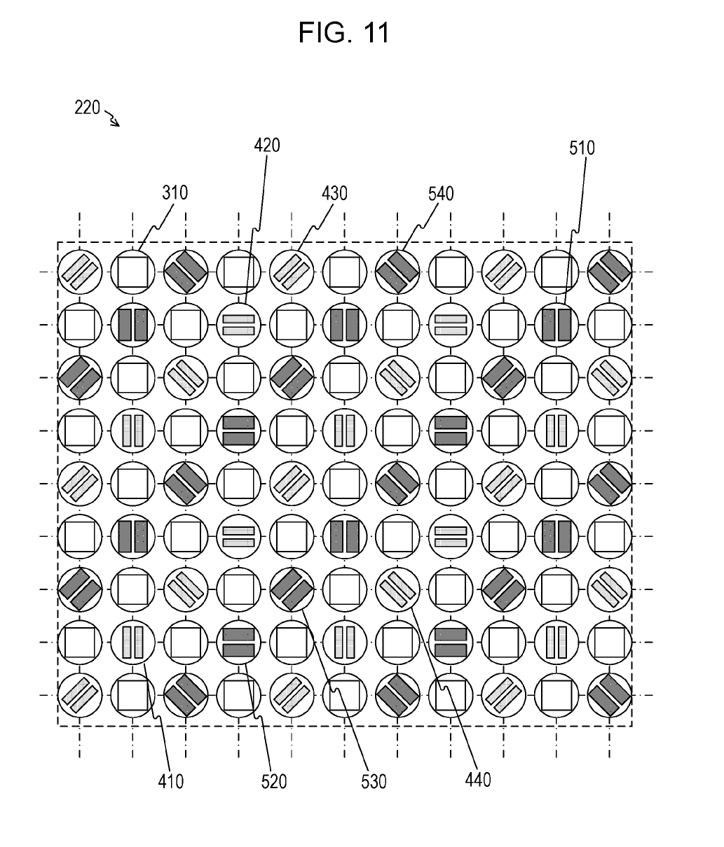

This focus detection areas 210 and 220 will be described in detail by using FIGS. 10 and 11.

FIG. 10 is a schematic diagram illustrating an example of a pixel arrangement in the focus detection area 210 according to the first embodiment.

The focus detection area 210 is an area where the focus detection pixels area arranged at the center, the center of the left edge, the center of the right edge, the center of the top edge, and the center of the bottom edge of the image sensor 200. In this focus detection area 230, for example, as illustrated in FIG. 10, the image pickup pixel 310 and the focus detection pixels 410, 420, 510, and 520 are arranged in a predetermined pattern. This pattern is a pattern where the image pickup pixel 310 is arranged so that it is possible to store pickup image data of the pixels where the focus detection pixels 410, 420, 510, and 520 are arranged. This predetermined pattern is, for example, as illustrated in FIG. 10, a pattern where the image pickup pixels 310 are arranged on the left, right, top and bottom of the focus detection pixels 410, 420, 510, and 520 are arranged.

FIG. 11 is a schematic diagram illustrating an example of a pixel arrangement in a focus detection area the focus detection area 220 according to the first embodiment.

The focus detection area 220 is an area where the focus detection pixels at the left edge in the top edge, the right edge in the bottom edge, the right edge in the top edge, and the left edge in the bottom edge of the image sensor 200 are arranged. In this focus detection area 220, for example, as illustrated in FIG. 11, the image pickup pixel 310, the focus detection pixels 410 to 440, and the focus detection pixels 510 to 540 are arranged in a similar pattern to FIG. 10.

In this manner, in alignment with the direction of the pupil division, as the focus detection pixels 410 to 440 and the focus detection pixels 510 to 540 are arranged in the image sensor 200, the first light receiving element and the second light receiving element can be efficiently irradiated with the light.

It should be noted that according to the first embodiment, as an example of the area where the focus detection pixels are arranged, the focus detection areas 210 and 220 are illustrated, but the present invention is not limited to this. Any arrangement of the focus detection pixels may suffice as long as the shift of the focus can be detected, and, for example, a case of an arrangement in line in the x axis direction or the like is also conceivable.

### [Focus Detection Characteristics in Focus Detection Pixels 410 and 510]

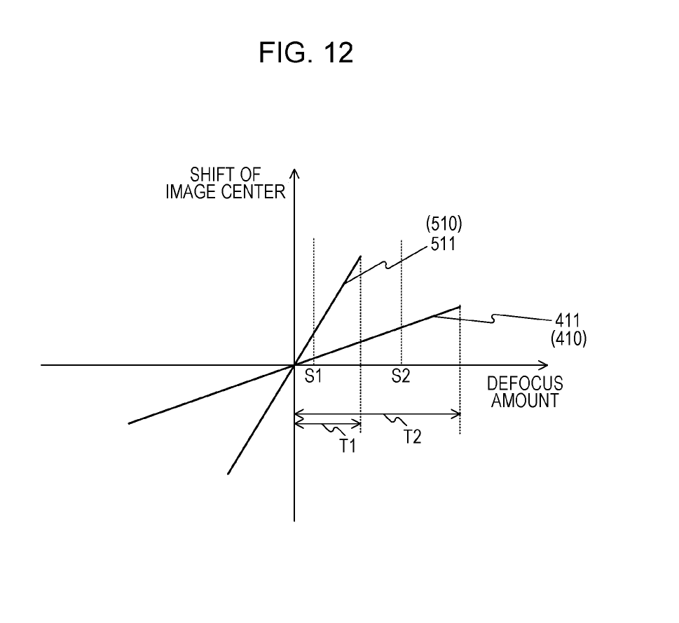

FIG. 12 schematically illustrates focus detection characteristics of the focus detection pixels 410 to 440 and the focus detection pixels 510 to 540 according to the first embodiment.

Herein, while an in-focus state is set as a reference, the focus detection characteristic refers to a characteristic indicating a correlation between a defocus amount that can be detected by the focus detection pixel and a shift amount of the center position of the image generated by the focus detection pixel. It should be noted that in FIGS. 12 to 14, for convenience sake, as the focus detection pixels, the image sensor 200 where the focus detection pixels 410 and 510 are alternately arranged in a single horizontal row (for example, the x axis direction illustrated in FIG. 9) is supposed for the description. Also, in the examples illustrated in FIGS. 12 to 14, it is supposed that a light source (subject) exists at the center of the image sensor 200.

In a graph illustrated in this FIG. 12, while the in-focus state is set as the origin, the horizontal axis is set as the shift amount of the focus (defocus amount), and the vertical axis is set as the shift amount of the center position of the image in the image data for focus adjustment. Also, in FIG. 12, it is supposed that the plus side on the horizontal axis is the defocus amount in a back focus, and the minus side on the horizontal axis is the defocus amount in a front focus. The graph in this FIG. 12 represents a detection characteristic 411 and a detection characteristic 511.

The detection characteristic 411 is a line schematically indicating the focus detection characteristic of the focus detection pixel 410. This detection characteristic 411 represents that the center position of the image of the image data for focus adjustment which is generated by the focus detection pixel 410 is shifted together with the shift of the focus from the in-focus state. Also, this detection characteristic 411 represents a range where the focus detection pixel 410 can detect the shift of the focus. For example, in the case of the back focus, the focus detection pixel 410 can detect the shift of the focus in a range indicated by a defocus amount section T2. Herein, the defocus amount section T2 indicates the defocus amount where the signal processing unit 130 can generate the image data for focus detection with which the center position of the image can be determined on the basis of the focus adjustment signal from the focus detection pixel 410.

The detection characteristic 511 is a line schematically indicating the focus detection characteristic of the focus detection pixel 510. This detection characteristic 511 represents that the center position of the image of the image data for focus adjustment which is generated by the focus detection pixel 510 is shifted together with the shift of the focus from the in-focus state. Also, this detection characteristic 511 represents a range where the focus detection pixel 510 can detect the shift of the focus. An inclination of this detection characteristic 511 is a larger inclination than the detection characteristic 411. That is, this detection characteristic 511 indicates that the focus detection pixel 510 can detect the defocus amount at a more satisfactory accuracy than the focus detection pixel 410.

Also, this detection characteristic 511 has a range where the shift of the focus can be detected is smaller than the detection characteristic 411. For example, in the case of the back focus, the focus detection pixel 510 can detect the shift of the focus in the range indicated by a defocus amount section T1. Herein, the defocus amount section T1 indicates the defocus amount where the signal processing unit 130 can generate the image data for focus detection with which the center position of the image can be determined on the basis of the focus adjustment signal from the focus detection pixel 510. It should be noted that the defocus amount section T1 is a narrower section as compared with the defocus amount section T2 and is a section indicating that the shift of the focus from in-focus is a small defocus amount. It should be noted that differences of the inclinations and the defocus amount sections in these detection characteristic 411 and the detection characteristic 511 are generated because as the incident angle of the like incident on the focus detection pixel is larger, the larger diffusion occurs when the focus is shifted.

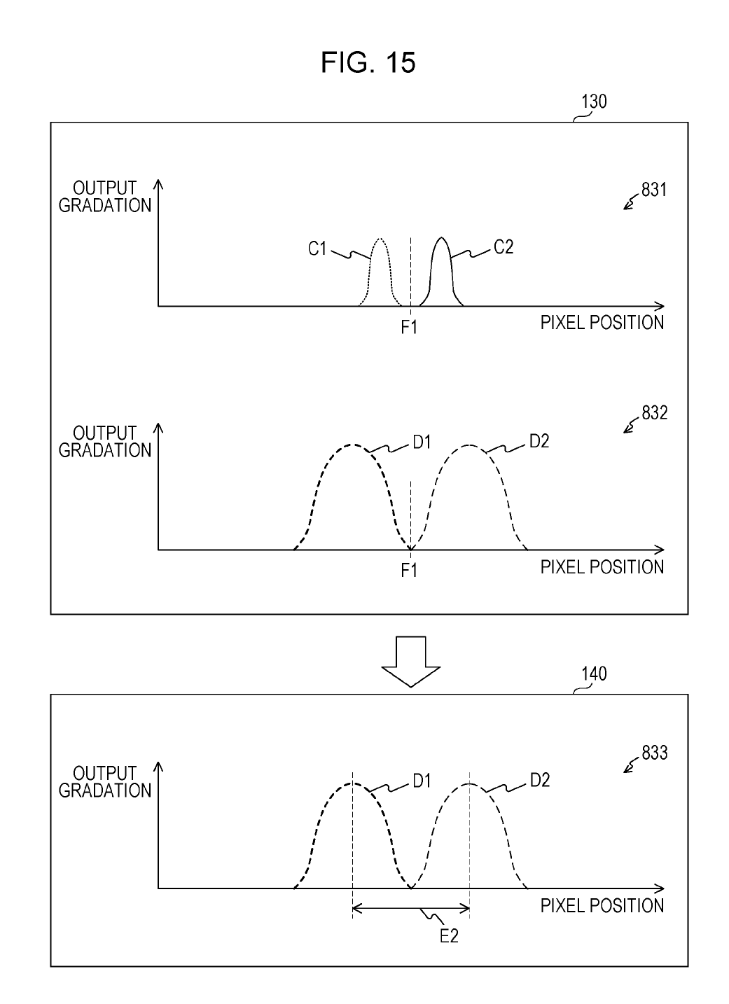

A defocus amount S1 indicates an example of a defocus amount where the defocus amount can be calculated by using any of the focus adjustment signals of the focus detection pixel 410, and the focus detection pixel 510. This defocus amount S1 will be described in detail by using FIG. 15.

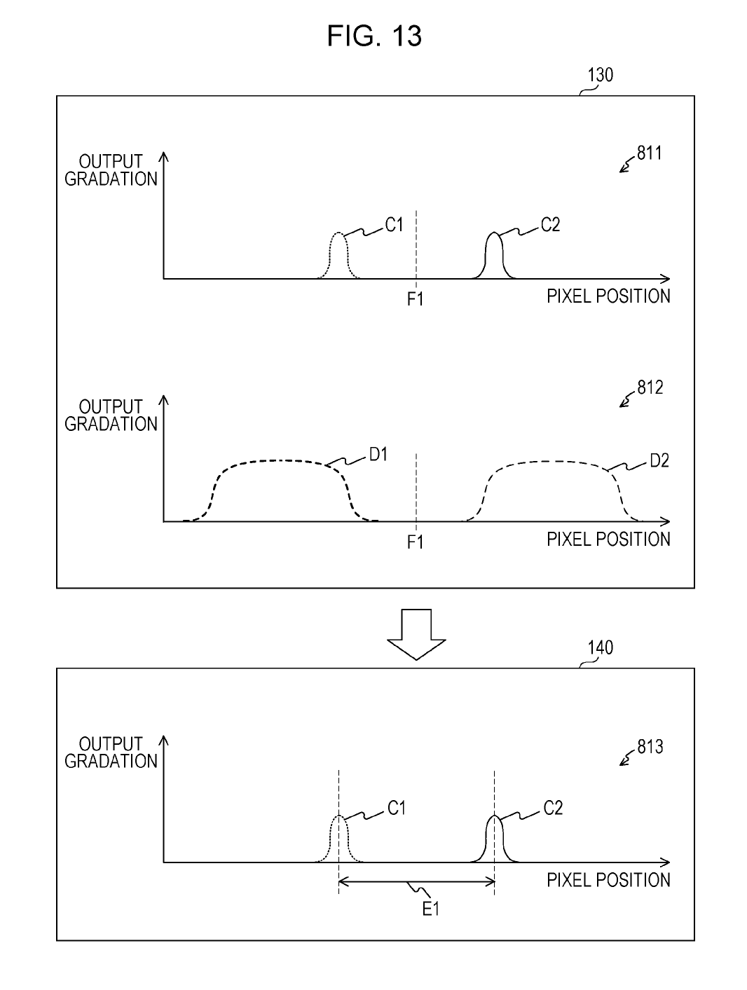

Also, a defocus amount S2 indicates an example of the defocus amount where the defocus amount cannot be calculated with the focus adjustment signal of the focus detection pixel 510, but the defocus amount can be calculated by using the focus adjustment signal of the focus detection pixel 410. This defocus amount S2 will be described in detail by using FIG. 13.

In this manner, the focus detection pixel 410 and the focus detection pixel 510 have the mutually different focus detection characteristics. The focus detection pixel 410 has the focus detection characteristic in which as the light equivalent to the irradiation light at the time of the F-number “5.6” is received, the width of the defocus amount that can be detected is wider. On the other hand, the focus detection pixel 510 has the focus detection characteristic in which as the light equivalent to the irradiation light at the time of the F-number “1.4” is received, although the width of the defocus amount that can be detected is narrow, the focus amount can be detected accurately.

### [Phase Difference Detection Example]

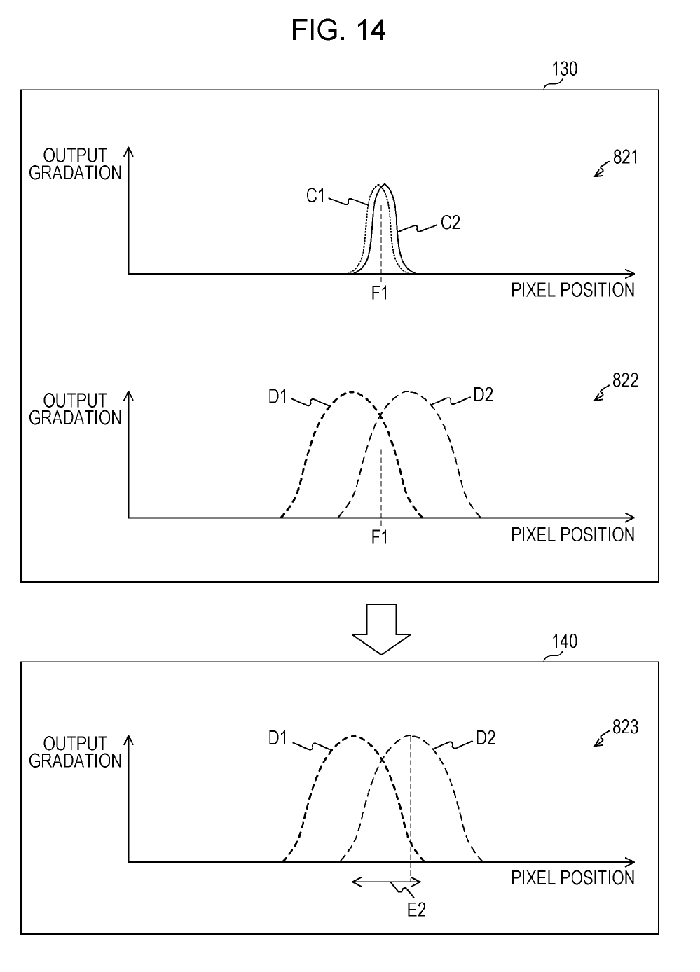

FIGS. 13 to 15 are schematic diagrams illustrating phase difference detection examples according to the first embodiment. In FIG. 13 and FIG. 14, an example, a description will be given while a case is supposed in which the focus is finely adjusted by using the focus detection pixel 510 after the focus is adjusted by using the focus detection pixel 410 in a case the shift of the focus is large. Also, in FIG. 15, as an example, in a case where the shift of the focus is small, an adjustment of the focus by using the focus detection pixel 510 without adjusting the focus by using the focus detection pixel 410 is supposed.

FIG. 13 illustrates a phase difference detection example in a case where the shift of the focus is large. In this FIG. 13, for example, similarly as in the defocus amount S2 illustrated in FIG. 12, a state is supposed in which the defocus amount cannot be calculated with the focus adjustment signal of the focus detection pixel 510, but if the focus adjustment signal of the focus detection pixel 410 is used, the defocus amount can be calculated. In this FIG. 13, a flow is schematically described in which the image data for focus adjustment of the focus detection pixel 410 is selected from the image data for focus adjustment generated from the focus adjustment signals of the focus detection pixels 410 and 510, and then, up until the control unit 140 detects the shift of the focus.

First, the image data for focus adjustment generated by the signal processing unit 130 will be described.

Image data 811 is a graph schematically illustrating the image data generated from the focus adjustment signal of the focus detection pixel 410 (image data for focus adjustment). This image data 811 represents image data for focus adjustment in which the horizontal axis is set as a pixel position of the focus detection pixel 410 in the image sensor, and the vertical axis is set as a gradation indicating the intensity of the focus adjustment signal of the focus detection pixel 410. In this image data 811, first light receiving element image data C1 and second light receiving element image data C2 are indicated.

The first light receiving element image data C1 is image data generated on the basis of the focus adjustment signal supplied by the first light receiving element 401 of the focus detection pixel 410. That is, this first light receiving element image data C1 indicates an intensity distribution in the image sensor for the light incident from the right side of the micro lens 311 (on the right side of the x axis of the micro lens 311 which is illustrated in FIG. 5A). In this FIG. 13, as it is the back focus, this first light receiving element image data C1 forms the image on the left with respect to a position F1 indicating the center position of the image data at the time of in-focus (center of the image sensor).

The second light receiving element image data C2 is image data generated on the basis of the focus adjustment signal supplied by the second light receiving element 402 of the focus detection pixel 410. That is, this second light receiving element image data C2 indicates an intensity distribution in the image sensor for the light incident from the left side of the micro lens 311 (on the left side of the x axis of the micro lens 311 which is illustrated in FIG. 5A). In this FIG. 13, as it is the back focus, this second light receiving element image data C2 forms the image on the right with respect to the position F1 indicating the center position of the image data at the time of in-focus.

Image data 812 is a graph schematically illustrating the image data generated from the focus adjustment signal from the focus detection pixel 510. This image data 812 represents the image data for focus adjustment in which the horizontal axis is set as the pixel position of the focus detection pixel 510 in the image sensor, and the vertical axis is set as the gradation indicating the intensity of the focus adjustment signal of the focus detection pixel 510. In this image data 812, first light receiving element image data D1 and second light receiving element image data D2 are indicated.

The first light receiving element image data D1 is image data generated on the basis of the focus adjustment signal supplied by the first light receiving element 501 of the focus detection pixel 510. That is, this first light receiving element image data D1 represents an intensity distribution in the image sensor the light incident from the right side of the micro lens 311 (on the right side of the x axis of the micro lens 311 which is illustrated in FIG. 5A). In this FIG. 13, as it is the back focus, this first light receiving element image data D1 forms the image on the left with respect to the position F1. Also, as compared with the first light receiving element image data C1, this first light receiving element image data D1 is image data whose intensity distribution of the light is gentle and is image data where the center of the image is unclear. A reason why the image data where the center of this image is unclear is that blur of the image is caused as the light is diffused.

The second light receiving element image data D2 is image data generated on the basis of the focus adjustment signal supplied by the second light receiving element 502 of the focus detection pixel 510. That is, this second light receiving element image data D2 indicates the intensity distribution in the image sensor the light incident from the left side of the micro lens 311 (on the left side of the x axis of the micro lens 311 which is illustrated in FIG. 5A). In this FIG. 13, as it is the back focus, this second light receiving element image data D2 forms the image on the right with respect to the position F1. A characteristic of this second light receiving element image data D2 is similar to that of the first light receiving element image data D1, and a description herein will thus be omitted.

In this manner, the signal processing unit 130 generates four pieces of image data for focal adjustment on the basis of the focus adjustment signals supplied by the focus detection pixel 410 and the focus detection pixel 510. Then, this signal processing unit 130 supplies the generated image data for focus adjustment to the control unit 140.

Next, an example of the focus detection in the control unit 140 will be described.

Focus detection comparison image data 813 is a graph schematically indicating two pieces of image data to be compared with each other when the focus detection is performed. This focus detection comparison image data 813 represents the two pieces of image data to be compared with each other in the focus detection (the first light receiving element image data C1 and the second light receiving element image data C2). It should be noted that this focus detection comparison image data 813 is a similar graph to the image data 811 other than an image interval E1.

Here, the operation of the control unit 140 will be described with reference to the focus detection comparison image data 813. First, the control unit 140 determines whether the image data for focus adjustment of either the focus detection pixel 410 or 510 is used by using the four pieces of the image data for focus adjustment supplied from the signal processing unit 130. This control unit 140 can accurately detect the difference of the focus by using the image data for focus adjustment where the center position of the image is clear and also the interval of the images is wider. For this reason, the control unit 140 determines that the image data for focus adjustment of the focus detection pixel 510 uses the image data for focus adjustment of the focus detection pixel 410 to detect the focus as the center position of the image is unclear.

Then, the control unit 140 detects the shift (the image interval E1) between the images of the first light receiving element image data C1 and the second light receiving element image data C2. After that, the control unit 140 decides a movement amount of the image pickup lens on the basis of the image interval E1 and supplies a signal for moving the image pickup lens to the drive unit 150.

In this manner, in a case where the shift amount of the focus is large, the defocus amount cannot be detected with the image data for focus adjustment of the focus detection pixel 510. However, the defocus amount can be detected by using the image data for focus adjustment of the focus detection pixel 410.

FIG. 14 illustrates a phase difference detection example in a case where after the focus is adjusted by using the focus detection pixel 410, the focus is finely adjusted by using the focus detection pixel 510. In this FIG. 14, on the basis of the image interval E1 illustrated in FIG. 13, a description will be given while a situation after the focus is adjusted is supposed.

First, the position of the image pickup lens is adjusted on the basis of the image interval E1 (FIG. 13), the image pickup of the subject is performs on the basis of the adjusted position of the image pickup lens, and the image data for focus adjustment of the focus detection pixel 410 and the focus detection pixel 510 is generated by the signal processing unit 130.

Image data 821 is an example of the image data for focus adjustment of the focus detection pixel 410 based on the adjusted position of the image pickup lens. This image data 821 is a graph indicating the image data for focus adjustment of the focus detection pixel 410 similarly as in the image data 811 of FIG. 13, and therefore a difference from the image data 811 illustrated in FIG. 13 will be described herein.

The first light receiving element image data C1 in FIG. 14 is image data in which the center of the image is substantially the same as the position F1. This applies the same also with regard to the second light receiving element image data C2. In this FIG. 14, as this is after the focus is adjusted on the basis of the image interval E1, the first light receiving element image data C1 and the second light receiving element image data C2 is so in proximity to the position F1 that it is difficult to adjust the focus with the image data for focus adjustment of the focus detection pixel 410.

Image data 822 is an example of the image data for focus adjustment of the focus detection pixel 510 based on the adjusted position of the image pickup lens. This image data 822 is a graph indicating the image data for focus adjustment of the focus detection pixel 510 similarly as in the image data 812 in FIG. 13, and therefore a difference from the image data 812 illustrated in FIG. 13 will be described herein.

The first light receiving element image data D1 in FIG. 14 is image data in which the position of the image is closer to the position F1 as compared with the first light receiving element image data D1 in FIG. 13 and also the center position of the image is clear. This applies the same also with regard to the second light receiving element image data D2. In this FIG. 14, as this is after the focus is adjusted on the basis of the image interval E1, the blur of the images of the first light receiving element image data D1 and the first light receiving element image data D1 is eliminated to an extent where the adjustment on the focus can be performed by using the image data for focus adjustment of the focus detection pixel 510.

Next, the focus detection in the control unit 140 will be described.

Focus detection comparison image data 823 is a graph schematically indicating two pieces of image data to be compared with each other at the time of the focus detection similarly as in the focus detection comparison image data 813 illustrated in FIG. 13. In this focus detection comparison image data 823, the first light receiving element image data D1 and the second light receiving element image data D2 are indicated. It should be noted that this focus detection comparison image data 823 is similar to the image data 822 other than an image interval E2.

Here, the operation of the control unit 140 will be described with reference to the focus detection comparison image data 823.

First, the control unit 140 determines whether the image data for focus adjustment of either the control unit 140 the focus detection pixel 410 or 510 is used. This control unit 140 determines that the focus is detected by using the image data for focus adjustment of the focus detection pixel 510 as the center position of the image of the image data for focus adjustment of the focus detection pixel 510 is clear.

Then, the control unit 140 detects the shift of the image between the first light receiving element image data D1 and the second light receiving element image data D2 (the image interval E2). After that, the control unit 140 decides the movement amount of the image pickup lens on the basis of the image interval E2 and supplies the signal for moving the image pickup lens to the drive unit 150.

In this manner, in a case where it is possible to detect the focus by using the image data for focus adjustment of the focus detection pixel 510, by preferentially using the image data for focus adjustment of the focus detection pixel 510 instead of the focus detection pixel 410, it is possible to detect the focus accurately.

FIG. 15 illustrates a phase difference detection example in a case where the shift of the focus is small according to the first embodiment. It should be noted that in this FIG. 15, similarly as in the state of the defocus amount S1 illustrated in FIG. 12, a state is supposed in which the defocus amount can be calculated by using either focus adjustment signal of the focus detection pixel 510 or the focus detection pixel 410.

In this FIG. 15, a difference from FIG. 13 will be described. It should be noted that image data 831 is a graph equivalent to the image data 811 of FIG. 13, image data 832 is a graph equivalent to the image data 812 in FIG. 13, and image data 833 is a graph equivalent to the image data 813 in FIG. 13. Also, in this FIG. 15, as this is a case where the shift of the focus is small, the first light receiving element image data C1 and the second light receiving element image data C2 refer to the images where the position of the image is close to the position F1. Also, the first light receiving element image data D1 and the second light receiving element image data D2 refer to the images where the position of the image is closer to the position F1 as compared with the first light receiving element image data D1 and the second light receiving element image data D2 in FIG. 13 and also the center position of the image is clear. However, the image data in this FIG. 15 is in a state in which the adjustment of the focus is not yet performed once, and therefore as compared with the image in FIG. 14, this is image data where the position of the image is farther from the position F1.

In this manner, in a case where it is possible to adjust the focus even when the image data for focus adjustment of any of the focus detection pixel 410 and the focus detection pixel 510 is used, the control unit 140 preferentially uses the image data for focus adjustment of the focus detection pixel 510 similarly as in FIG. 14. With this configuration, it is possible to adjust the focus promptly and accurately.

### [Operation Example of Control Unit]

Next, an operation of the image pickup apparatus 100 will be described with reference to the drawings according to the first embodiment.

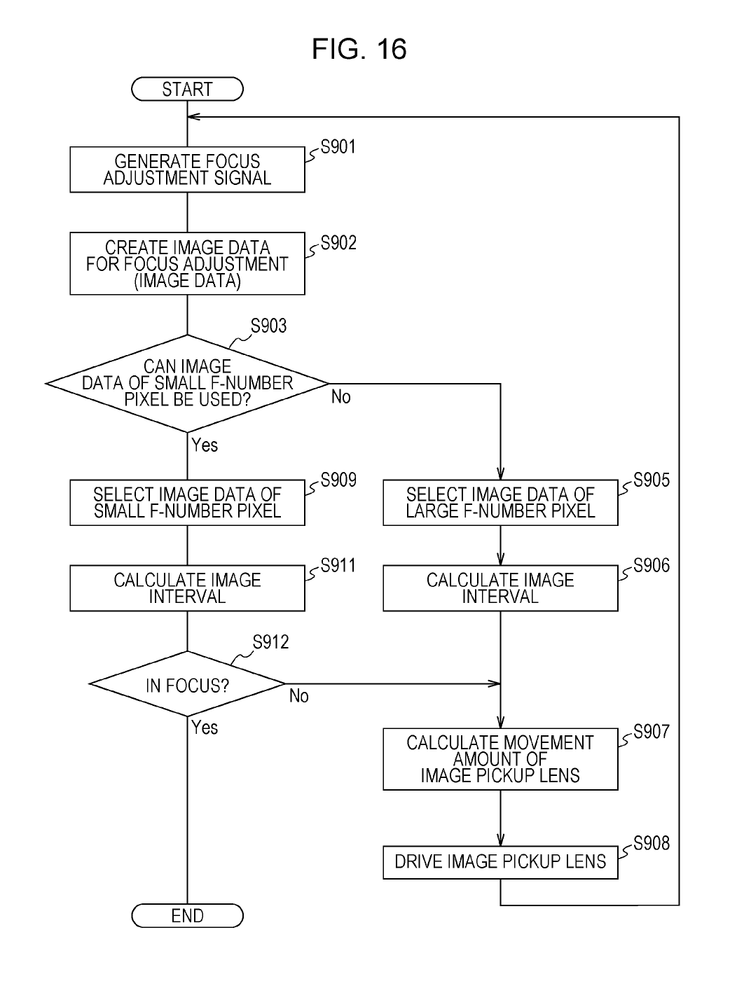

FIG. 16 is a flow chart illustrating a focus control procedure example by the image pickup apparatus 100 according to the first embodiment.

In FIG. 16, a procedure from the start of the focus control in a case where the image pickup of the subject is performed to the end of the focus control as a result of in-focus.

First, the image of the subject is picked up by the focus detection pixel in the image sensor 200, and a focus adjustment signal is generated (step S901). Subsequently, on the basis of the focus adjustment signal, the image data for focus adjustment is generated by the signal processing unit 130 (step S902). It should be noted that step S901 is an example of image pickup means described in the scope of claims.

Next, the control unit 140 determines whether or not the image data for focus adjustment generated from the focus detection pixels 510 to 540 (in this FIG. 16, which will be referred to as large F-number pixel) among the generated image data for focus adjustment can be used for the calculation of the image interval (step S903). Then, in a case where the image data for focus adjustment of the small F-number pixel cannot be used, the image data for focus adjustment generated from the focus adjustment signals of the focus detection pixels 410 to 440 (in FIG. 16, which will be referred to as small F-number pixel) is selected by the control unit 140 (step S905). Herein, a case in which it is determined that the image data for focus adjustment of the small F-number pixel cannot be used means, for example, a case in which the focus is significantly shifted as illustrated in FIG. 13. Then, on the basis of the selected image data for focus adjustment of the small F-number pixel, the image interval is calculated (step S906). After that, on the basis of the calculated image interval, the drive amount (movement amount) of the image pickup lens in the lens unit 110 is calculated by the control unit 140 (step S907). Subsequently, the image pickup lens in the lens unit 110 is driven by the drive unit 150 (step S908), and the processing proceeds to step S901.

On the other hand, in a case where it is determined that the image data for focus adjustment generated from the focus adjustment signal of the small F-number pixel can be used (step S903), the image data for focus adjustment of the small F-number pixel is selected by the control unit 140 (step S909). Then, on the basis of the selected image data for focus adjustment of the small F-number pixel, the image interval is calculated (step S911). Next, on the basis of the calculated image interval, the control unit 140 determines whether or not focusing is effected (step S912). Then, in a case where it is determined that focusing is not effected (step S912), the processing proceeds to step S907, and from the image data for focus adjustment of the large F-number pixel, on the basis of the calculated image interval, the drive amount (movement amount) of the image pickup lens is calculated. It should be noted that step S912 is an example of determination means described in the scope of claims.

On the other hand, in a case where it is determined that focusing is effected (step S912), the focus control procedure ends.

In this manner, according to the first embodiment, by providing the focus detection pixels 410 to 440 and the focus detection pixels 510 to 540 to the image sensor 200, it is possible to perform the adjustment on the focus at a high precision.

### 2. Second Embodiment

According to the first embodiment, the example has been described where the focus detection pixels in which the size of a pair of light receiving elements is narrow and the focus detection pixels in which the size of a pair of light receiving elements is large are used. The focus detection pixels 510 to 540 which are these focus detection pixels in which the size of a pair of light receiving elements is large receive both lights including the light irradiated with the area close to the axis L1 (the light distribution area A1) and the light irradiated with the area away from the axis L1 (the light distribution area A2). These focus detection pixels 510 to 540 are for the purpose of receiving the light irradiated with the area far from the axis L1 (the light distribution area A2), and therefore focus detection pixels that receive only the light irradiated with the light distribution area A2 can be used instead of the focus detection pixels 510 to 540.

In view of the above, according to the second embodiment, an example of using the focus detection pixels that receive only the light irradiated with the area far from the axis L1 (the light distribution area A2) instead of the focus detection pixels 510 to 540 will be described.

### [Configuration Example of Focus Detection Pixel]

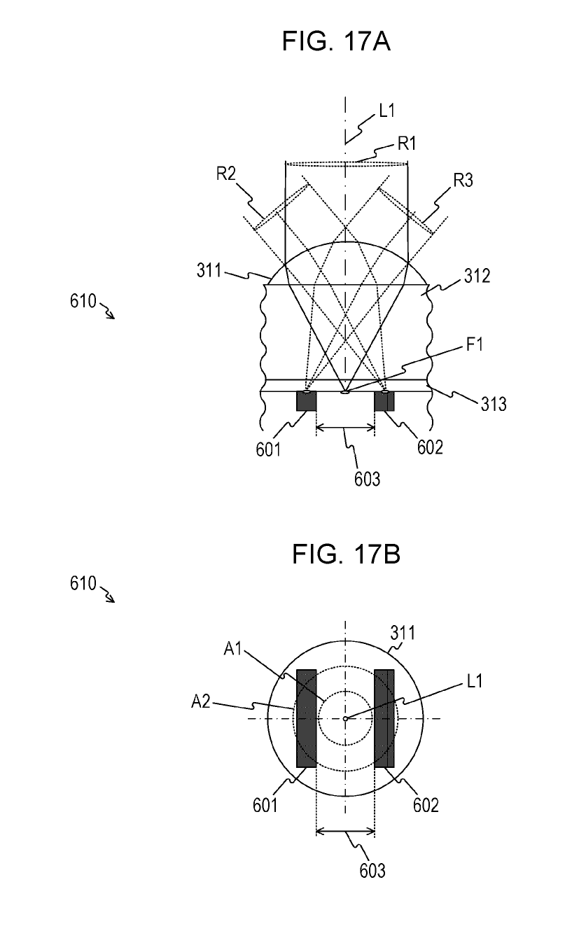

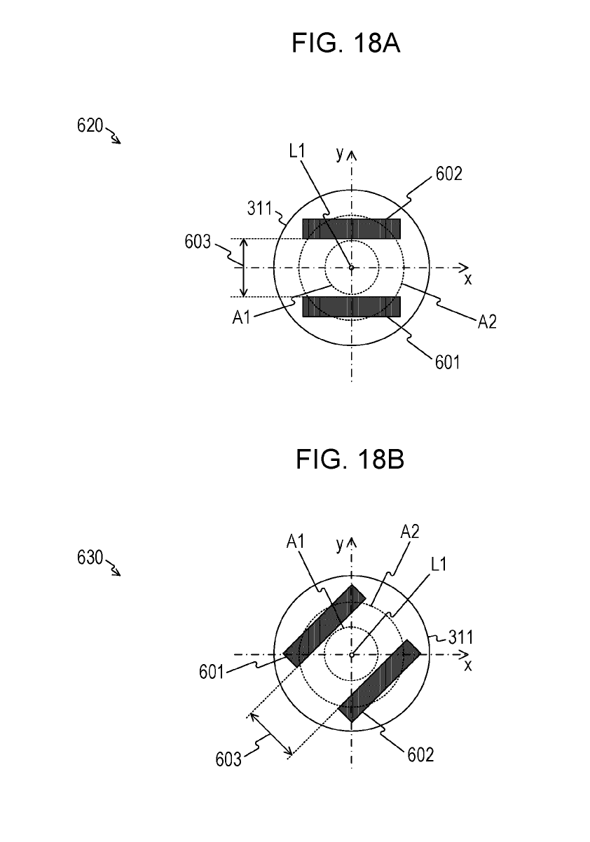

FIG. 17 is a cross sectional view and FIG. 18 is a top view schematically illustrating an example of a focus detection pixel 610 according to the second embodiment.

It should be noted that according to the second embodiment, the micro lens 311 in the focus detection pixel 610 is set to be the same as the micro lens 311 of the image pickup pixel 310 illustrated in FIGS. 2A and 2B.

Also, according to the second embodiment, it is set that the size of the entire pixel of the focus detection pixel 610 is the same size as the image pickup pixel 310 illustrated in FIGS. 2A and 2B. Also, according to the second embodiment, it is set that the center of the focus detection pixel 610 and the axis L1 are located on the same axis.

FIG. 17A schematically illustrates a cross sectional configuration of the focus detection pixel 610. This FIG. 17A illustrates the cross sectional configuration in a case where the left and right direction of FIG. 17A is set as the narrow side direction of the light receiving element in the focus detection pixel 610.

It should be noted that in this FIG. 17A, as configurations other than a first light receiving element 601, a second light receiving element 602, and an element separation area 603 are identical to the respective configurations of the image pickup pixel 310 illustrated in FIG. 2A, the same reference symbols as those of FIG. 2A are assigned, and a description herein will be omitted. Also, incident light on the focus detection pixel 610 is similar to that of FIG. 2A, and a description herein will thus be omitted.

The first light receiving element 601 is a light receiving element that forms a pair with the second light receiving element 602 and is arranged to receive only the light at a large angle with respect to the axis L1 among one light of the incident lights subjected to the pupil division. That is, this first light receiving element 601 receives only the light passing through a location away from the center of the image pickup lens. This first light receiving element 601 has, for example, a narrow rectangular shape is arranged at a position where the range R3 irradiation light at a position far from the axis L1 is irradiated. This first light receiving element 601 generates a current at an intensity in accordance with the amount of the received light by converting the received light into the current (photoelectric conversion) similarly as in the light receiving element 314 illustrated in FIG. 2A.

The second light receiving element 602 is a light receiving element that forms a pair with the first light receiving element 601 and is arranged to receive the other incident light subjected to the pupil division that is different from the light received by the first light receiving element 601. This second light receiving element 402 is the same receiving light element as the first light receiving element 601 in terms of the size and the performance. A function of this second light receiving element 602 is similar to the function of the first light receiving element 601, and a description herein will thus be omitted.

The element separation area 603 is an insulating area located between the first light receiving element 601 and the second light receiving element 602 similarly as in the element separation area 403 illustrated in FIGS. 3A and 3B. As the first light receiving element 601 and the second light receiving element 602 are narrow rectangular located at a position away from the axis L1, this element separation area 603 is an area with a larger wider as compared with the element separation area 403 illustrated in FIGS. 3A and 2B. This element separation area 603 is similar to the element separation area 403 other than the width, and a description herein will thus be omitted.

FIG. 17B illustrates an irradiation position example of the light incident on the focus detection pixel 610 illustrated in FIG. 17A.

Here, the light received by the first light receiving element 601 and the second light receiving element 602 of the focus detection pixel 610 will be described while being compared with the focus detection pixel 410 in FIG. 3B, and the focus detection pixel 510 in FIG. 6B.

As illustrated in this FIG. 17B, the first light receiving element 601 of the focus detection pixel 610 can receive the light incident on the left side of the light distribution area A2 (on the focus plane, the minus side in the x axis direction with respect to the axis L1). Similarly, the second light receiving element 602 can receive the light incident on the right side of the light distribution area A2 (on the focus plane, the plus side in the x axis direction with respect to the axis L1). That is, as compared with the focus detection pixel 410, this focus detection pixel 610 receives the irradiation light in the area far from the axis L1 (the light distribution area A2) that is not received by the focus detection pixel 410. Also, as compared with the focus detection pixel 510, this focus detection pixel 610 does not receive the light irradiated with the light distribution area A1 but receives only the irradiation light in the light distribution area A2.

The focus detection pixel 610 is different from the focus detection pixel 410 only in the arrangement position for the light receiving element if the size of the first light receiving element 601 and the second light receiving element 602 is the same as that of the light receiving element of the focus detection pixel 410 illustrated in FIGS. 3A and 3B. That is, in the focus detection pixel 610, the distance between the end portions on the axis L1 side of one pair of the light receiving elements (width of the element separation area 603) is larger than the distance between the end portions on the axis L1 side of one pair of the light receiving elements of the focus detection pixel 410 (width of the element separation area 403). Also, in the focus detection pixel 610, the distance between the end portions on the outer-side with respect to the axis L1 of one pair of the light receiving elements (total of widths of one pair of the light receiving elements and the element separation area 503) is larger than the distance between the end portions on the outer-side with respect to the axis L1 of one pair of the light receiving elements of the focus detection pixel 410.

It should be noted that in these FIGS. 17A and 17B, the description has been given in which the shape of the first light receiving element 601 and the second light receiving element 602 is the narrow rectangular, but the present invention is not limited to this. These first light receiving element 601 and second light receiving element 602 may have a shape with which it is possible to receive the light irradiated with the area far from the axis L1 (for example, the light distribution area A2). For that reason, for example, among the first light receiving element 501 and the second light receiving element 502 of the focus detection pixel 510 illustrated in FIGS. 6A and 6B, one obtained by removing a part in an area equivalent to the light distribution area A1 or the like is conceivable.

### [Light Receiving Example of Focus Detection Pixels 620 to 640]

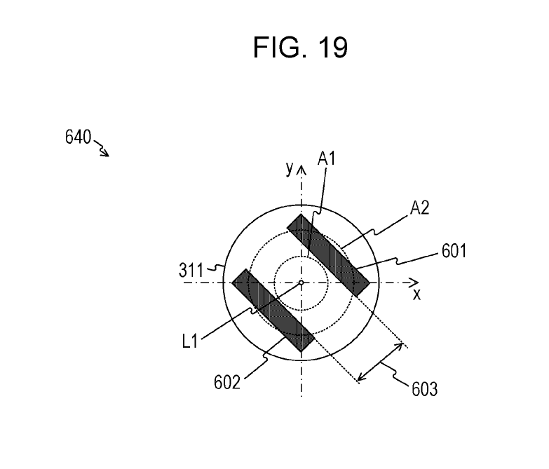

FIGS. 18A, 18B, and 19 are schematic diagrams illustrating light receiving examples of light incident on focus detection pixels 620 to 640 according to the second embodiment.

In FIGS. 18A, 18B, and 19, with regard to the focus detection pixels 620 to 640, a difference from the focus detection pixel 610 illustrated in FIG. 17B will be described. It should be noted that cross sectional configurations of the focus detection pixels 620 to 640 are the same as the cross sectional configuration of the focus detection pixel 610 illustrated in FIG. 17A, and a description herein will thus be omitted.

FIGS. 18A and 18B are top views schematically illustrating the focus detection pixels 620 and 630 according to the second embodiment.

As illustrated in FIG. 18A, while the origin of the xy coordinate system is set as the rotation center, the focus detection pixel 620 is obtained by rotating clockwise the focus detection pixel 610 illustrated in FIG. 17A by 90°. This focus detection pixel 620 can receive the irradiation light in the area far from the axis L1 (the light distribution area A2) among the lights subjected to the pupil division in the up and down direction of the micro lens 311 (positive and negative on the y axis).

As illustrated in FIG. 18B, while the origin of the xy coordinate system is set as the rotation center, the focus detection pixel 630 is obtained by rotating clockwise the focus detection pixel 610 illustrated in FIG. 17A by 315°. This focus detection pixel 630 can receive the irradiation light in the area far from the axis L1 (the light distribution area A2) among the lights subjected to the pupil division in the direction of the upper left and the lower right of the micro lens 311 (divided by the line of y=x).

FIG. 19 is a top view schematically illustrating the focus detection pixel 640 according to the second embodiment.

While the origin of the xy coordinate system is set as the rotation center, the focus detection pixel 640 is obtained by rotating clockwise the focus detection pixel 610 illustrated in FIG. 17A by 225°. This focus detection pixel 640 can receive the irradiation light in the area far from the axis L1 (the light distribution area A2) among the lights subjected to the pupil division in the direction of the lower left and the upper right of the micro lens 311 (divided by the line of y=−x).

In this manner, in the focus detection pixels 610 to 640 illustrated in FIGS. 17 and 18, among the irradiation light at the F-number “1.4” that is incident on the focus detection pixel, the light irradiated only at the time of a small F-number (for example, smaller than or equal to the F-number “5.6”) can be received by a pair of light receiving elements. According to this, the control unit 140 can adjust the focus on the basis of the light irradiated only at the time of the small F-number.

### [Arrangement Example of Focus Detection Pixels in Image Sensor]

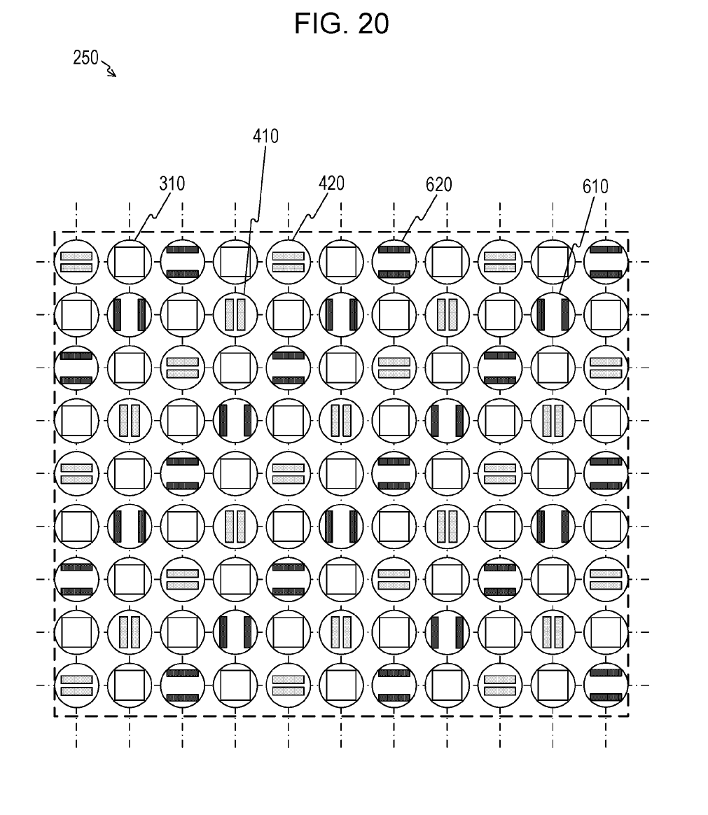

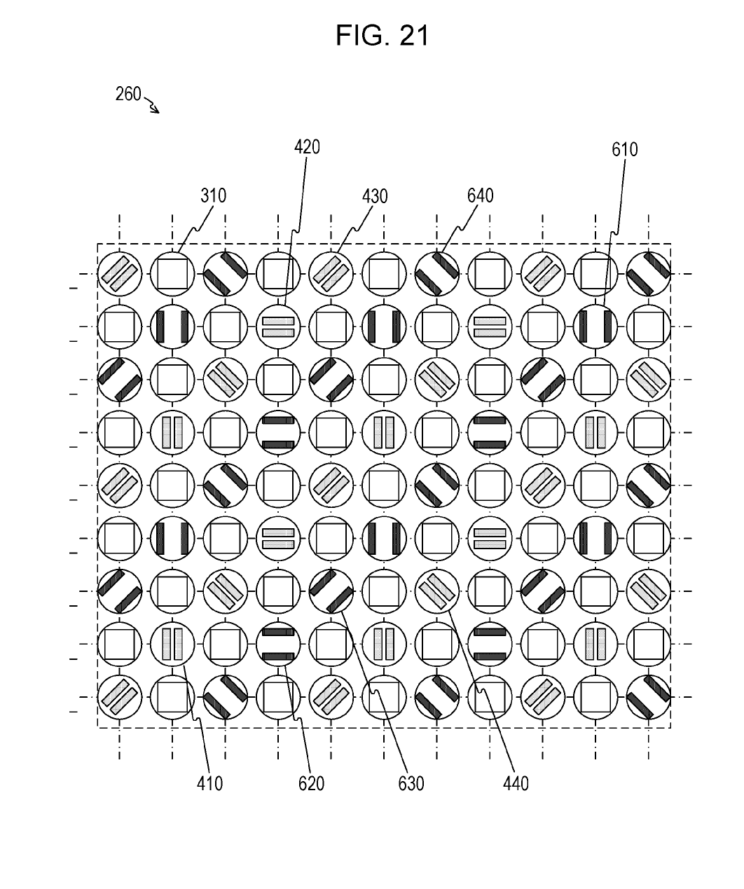

FIG. 20 and FIG. 21 illustrate a focus detection area 250 and a focus detection area 260 as examples of an area where the focus detection pixels equivalent to the focus detection areas 210 and 220 illustrated according to the first embodiment are arranged.

FIG. 20 is a schematic diagram illustrating an example of a pixel arrangement in the focus detection area 250 according to the second embodiment.

The focus detection area 250 is configured to be provided with the focus detection pixels 610 and 620 instead of the focus detection pixels 510 and 520 in the focus detection area 250 illustrated in FIG. 10. An area like this focus detection area 250 is provided in the image sensor 200.

FIG. 21 is a schematic diagram illustrating an example of a pixel arrangement in the focus detection area 260 according to the second embodiment.

The focus detection area 260 is configured to be provided with the focus detection pixels 610 to 640 instead of the focus detection pixels 510 to 540 in the focus detection area 220 illustrated in FIG. 11. An area like this focus detection area 260 is provided in the image sensor 200.

In this manner, according to the second embodiment, by providing the focus detection pixels 410 to 440 and the focus detection pixels 610 to 640 to the image sensor 200, similarly as in the first embodiment, it is possible to perform the adjustment on the focus at a high precision.

### [Phase Difference Detection Example]

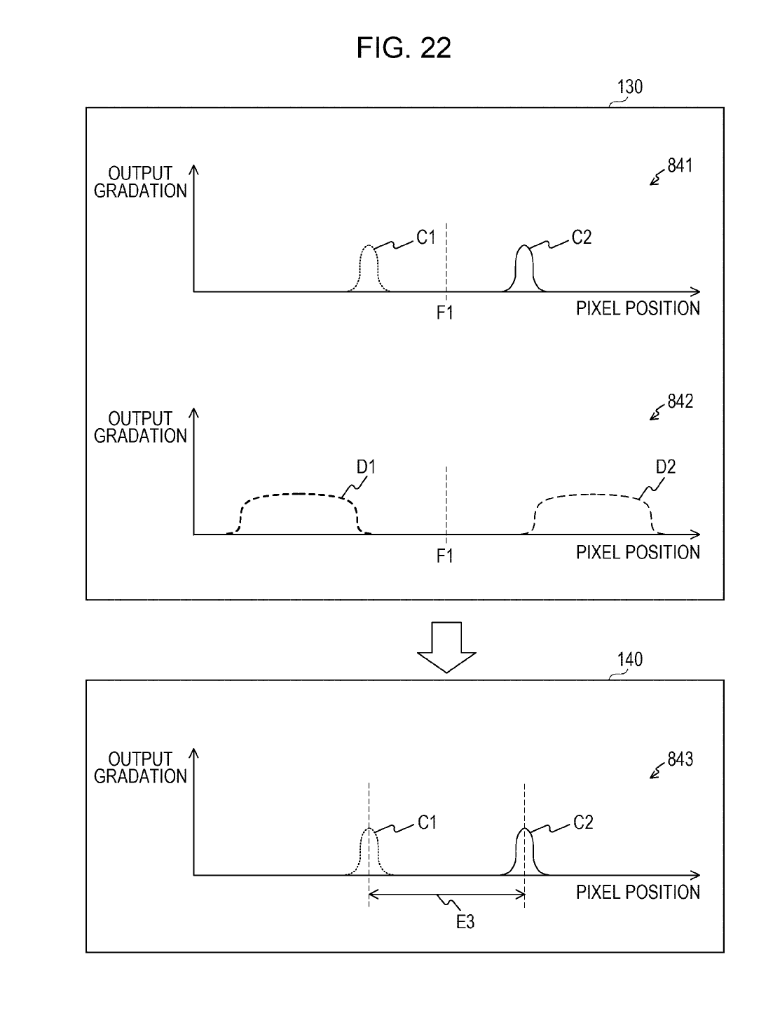

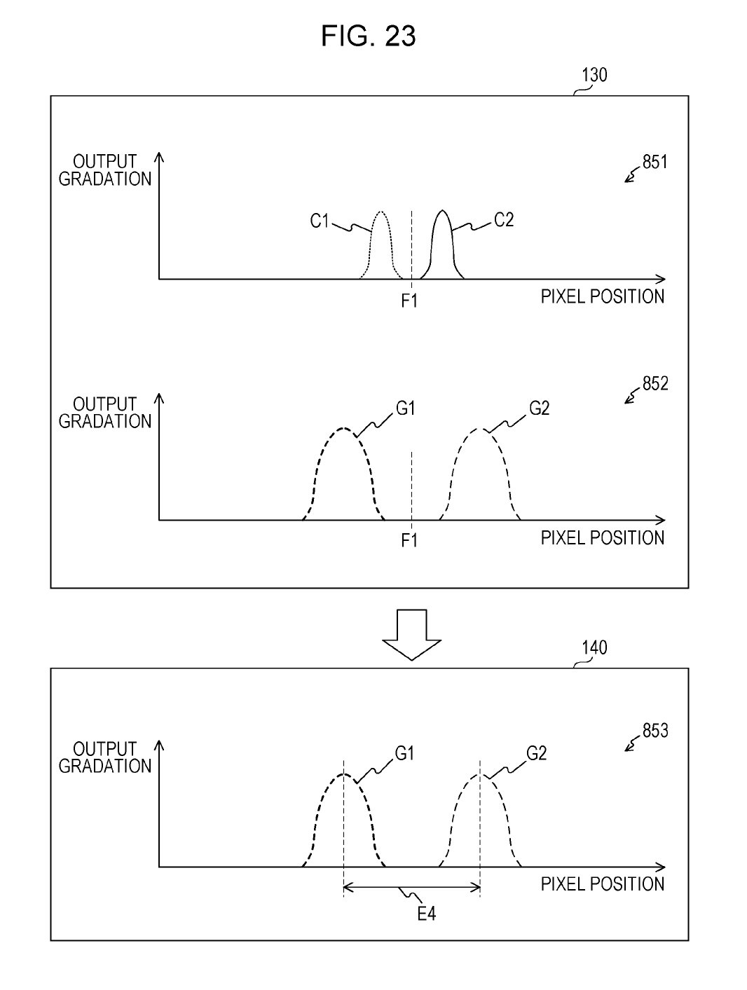

FIG. 22 and FIG. 23 are schematic diagrams illustrating phase difference detection examples according to the second embodiment. FIG. 22 illustrates an example equivalent to the phase difference detection example in a case where the shift of the focus is large which is illustrated in FIG. 13. Also, FIG. 23 illustrates an example equivalent to the phase difference detection example in a case where the shift of the focus is small which is illustrated in FIG. 15.

FIG. 22 illustrates a phase difference detection example in a case where the shift of the focus is large according to the second embodiment.

Image data 841 schematically represents image data generated from the focus adjustment signal from the focus detection pixel 410. This image data 841 is similar to the image data 811 illustrated in FIG. 13, and a description herein will thus be omitted.

Image data 842 is a graph schematically representing image data (image data for focus adjustment) generated from the focus adjustment signal from the focus detection pixel 610. Also, in this image data 842, first light receiving element image data G1 and second light receiving element image data G2 are indicated.

The first light receiving element image data G1 is image data generated on the basis of the focus adjustment signal supplied by the first light receiving element 601 of the focus detection pixel 610. The second light receiving element image data G2 is image data generated on the basis of the focus adjustment signal supplied by the second light receiving element 602 of the focus detection pixel 610. This first light receiving element image data G1 and the second light receiving element image data G2 are substantially similar to the first light receiving element image data D1 and the second light receiving element image data D2 illustrated in FIG. 13, and a description herein will thus be omitted.

Focus detection comparison image data 843 schematically represents two pieces of image data to be compared with each other when the focus detection is performed. This focus detection comparison image data 843 is similar to the focus detection comparison image data 813 illustrated in FIG. 13, and a description herein will thus be omitted.

In this manner, in a case where the shift of the focus is large, even when the focus detection pixel 610 is used instead of the focus detection pixel 510, it is possible to adjust the focus similarly as in the first embodiment.

FIG. 23 illustrates a phase difference detection example in a case where the shift of the focus is small according to the second embodiment.

Image data 851 schematically represents the image data generated from the focus adjustment signal from the focus detection pixel 410. This image data 851 is similar to the image data 811 illustrated in FIG. 13, and a description herein will thus be omitted.

Image data 852 is a graph schematically representing the image data generated from the focus adjustment signal from the focus detection pixel 610. This image data 852 indicates the first light receiving element image data G1 and the second light receiving element image data G2. It should be noted that the description of this image data 852 is substantially similar to the description of the image data 832 illustrated in FIG. 15 and the image data 842 illustrated in FIG. 23, and a description herein will thus be omitted.

In this manner, in a case where the shift of the focus is small, even when the focus detection pixel 610 is used instead of the focus detection pixel 510, it is possible to adjust the focus similarly as in the first embodiment.

It should be noted that the focus detection pixel 610 receives only the light irradiated with the area far from the axis L1 (for example, the light distribution area A2) (light where the image is blurred as being swiftly diffused when the focus is shifted as the incident angle is large). For this reason, as compared with the image data for focus adjustment of the focus detection pixel 510, the image data for focus adjustment of the focus detection pixel 610 has a larger change in the image with respect to the shift of the focus.

### 3. Third Embodiment

The focal detection pixel according to the first embodiment and the second embodiment is provided with a pair of light receiving elements to one focal detection pixel and therefore generates two focus adjustment signals. For that reason, by devising the read out method for these two focus adjustment signals, the speed of the focus control can be improved. In view of the above, according to the third embodiment, an example will be described in which a second signal line used only for reading out one focus adjustment signal among the two focus adjustment signals is provided.

### [Configuration Example of Image Sensor]

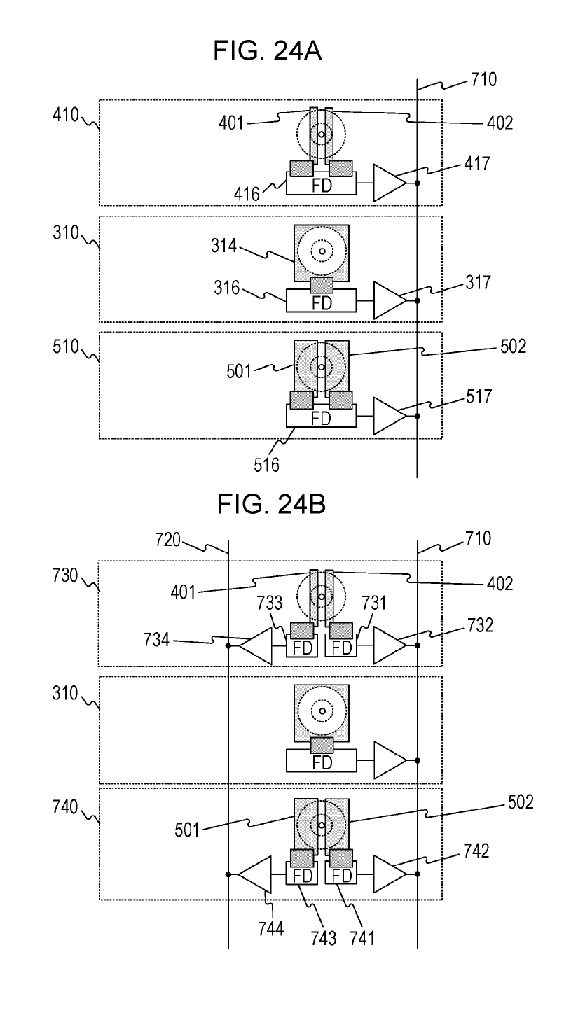

FIGS. 24A and 24B are schematic diagrams illustrating examples of signal lines of the image sensor 200 according to a third embodiment.

FIGS. 24A and 24B illustrate the image pickup pixel 310, the focus detection pixels 410 and 510, the image pickup pixel 310, focus detection pixels 730 and 740, according to the third embodiment, which are connected to a signal line similar to that of the image sensor 200 in the conventional image pickup apparatus.

FIG. 24A schematically illustrates the image pickup pixel 310 and the focus detection pixels 410 and 510 connected to the signal line similarly as in the image sensor 200 in the conventional image pickup apparatus. In this FIG. 22A, the upper stage illustrates the focus detection pixel 410, the center illustrates the image pickup pixel 310, and the lower stage illustrates the focus detection pixel 510.

Also, for the image pickup pixel 310, the light receiving element 314, an FD (Floating Diffusion) 316, and an amplifier 317 are illustrated. Also, for the focus detection pixel 410, the first light receiving element 401, the second light receiving element 402, the FD 416, and an amplifier 417 are illustrated. Furthermore, for the focus detection pixel 510, the first light receiving element 501, the second light receiving element 502, an FD 516, and an amplifier 517 are illustrated.

It should be noted that the light receiving element 314 in the image pickup pixel 310 and the first light receiving element 401 and the second light receiving element 402 in the focus detection pixel 410 are similar to those according to the first embodiment, and a description herein will thus be omitted. Also, the first light receiving element 501 and the second light receiving element 502 in the focus detection pixel 510 are similar to those according to the first embodiment, and a description herein will thus be omitted.

The FD 316, the FD 416, and the FD 516 are floating diffusions for the image pickup pixel 310, the focus detection pixel 410, and the focus detection pixel 510. These FD 316, FD 416, and FD 516 detect charges of the light receiving elements. These FD 316, FD 416, and FD 516 converts the detected charges into voltages to be supplied to the amplifier 317, the amplifier 417, and the amplifier 517.

The amplifier 317, the amplifier 417, and the amplifier 517 are configured to amplify the voltages supplied from the FD 316, the FD 416, and the FD 516. These amplifier 317, amplifier 417, and amplifier 517 supply the amplified voltages to a first column signal line 710.

The first column signal line 710 is a signal line for reading out the image pickup signal generated by the image pickup pixel 310 and the focus adjustment signals generated by the focus detection pixel 410, and the focus detection pixel 510. The image pickup signal and the focus adjustment signals are read out via this first column signal line 710 to the signal processing unit 130. For example, first, the focus adjustment signal of the first light receiving element 401 in the focus detection pixel 410 in the upper stage of FIG. 24A is read out. Subsequently, the focus adjustment signal of the second light receiving element 402 in the focus detection pixel 410 in the upper stage is read out, and then, the image pickup signal of the image pickup pixel 310 in the center is read out. After that, the focus adjustment signal of the first light receiving element 501 in the focus detection pixel 510 in the lower stage is read out, and finally, the focus adjustment signal of the second light receiving element 502 in the focus detection pixel 510 in the lower stage is read out.

In this manner, in a case where the focus adjustment signals of the focus detection pixel 410 and the focus detection pixel 510 are read out via the single signal line, a necessity arises to perform read out of the focus adjustment signal from each of the focus detection pixel 410 and the focus detection pixel 510 two times.

FIG. 24B schematically illustrates the image pickup pixel 310, the focus detection pixel 410, and the focus detection pixel 510 to which the signal line of the image sensor 200 according to the third embodiment is connected. In this FIG. 24B, the upper stage illustrates the focus detection pixel 730, the center illustrates the image pickup pixel 310, and the lower stage illustrates the focus detection pixel 740.

To the first column signal line 710, the image pickup pixel 310 (center), the second light receiving element 402 in the focus detection pixel 730, and the second light receiving element 502 in the focus detection pixel 740 are connected. To a second column signal line 720, the first light receiving element 401 in the focus detection pixel 730 and the first light receiving element 501 in the focus detection pixel 740 are connected.

Here, a difference from the image sensor 200 in the conventional image pickup apparatus illustrated in FIG. 24A will be described. It should be noted that components other than the focus detection pixel 730, the focus detection pixel 740, and the second column signal line 720 are similar to those illustrated in FIG. 24A, and a description herein will thus be omitted.

The focus detection pixel 730 is obtained by separately connecting the first light receiving element 401 and the second light receiving element 402 of the focus detection pixel 410 illustrated in FIG. 24A to the first column signal line 710 and the second column signal line 720. This focus detection pixel 730 is provided with an FD 733 for detecting charge of the first light receiving element 401 to be converted into a voltage and an amplifier 734 for amplifying the converted voltage. Also, this focus detection pixel 730 is provided with an FD 731 for detecting charge of the second light receiving element 402 to be converted into a voltage and an amplifier 732 for amplifying the converted voltage.

The focus detection pixel 740 is obtained by separately connecting the first light receiving element 501 and the second light receiving element 502 of the focus detection pixel 510 illustrated in FIG. 24A to the first column signal line 710 and the second column signal line 720. This focus detection pixel 740 is provided with an FD 743 for detecting charge of the first light receiving element 501 to be converted into a voltage and an amplifier 744 for amplifying the converted voltage. Also, this focus detection pixel 740 is provided with an FD 741 for detecting charge of the second light receiving element 502 to be converted into a voltage and an amplifier 742 for amplifying the converted voltage.

The second column signal line 720 is a signal line for reading out the focus adjustment signals generated by the first light receiving element 401 in the focus detection pixel 730 and the first light receiving element 501 in the focus detection pixel 740. This second column signal line 720 takes out he focus adjustment signal of the first light receiving element 401 in the focus detection pixel 730 simultaneously at a timing when the first column signal line 710 takes out the focus adjustment signal of the second light receiving element 402 in the focus detection pixel 730. Also, this second column signal line 720 takes out the focus adjustment signal of the first light receiving element 501 in the focus detection pixel 740 simultaneously at a timing when the first column signal line 710 takes out the focus adjustment signal of the second light receiving element 502 in the focus detection pixel 740.

In this manner, according to the third embodiment, by providing the second column signal line 720, the time used for the supply of the focus adjustment signal to the signal processing unit 130 can be shortened. According to this, the time used for the generation of the image data for focus adjustment can be shortened, and the time used for the focus control can be shortened.

In this manner, according to the embodiments, by providing the light receiving element that receives the light irradiated with the area close to the axis L1 and the light receiving element that receives the light irradiated with the area far from the axis L1 in the image sensor, the accuracy of the focus adjustment can be improved.

Although modifications and changes may be suggested by those skilled in the art, it is the intention of the inventors to embody within the patent warranted hereon all changes and modifications as reasonably and properly come within the scope of their contribution to the art.

Also, the processing procedure described in the embodiments may be grasped as a method including these series of procedures and also may be grasped as a program for causing a computer to execute these series of procedures or a recording medium storing the program. For this recording medium, for example, a CD (Compact Disc), an MD (MiniDisc), a DVD (Digital Versatile Disk), a memory card, a Blu-ray Disc (Blu-ray Disc (registered trademark)) or the like can be used.

What is claimed is:

1. A solid-state image pickup device, comprising:
a first unit to convert light into an electrical signal, the first unit including:
a first lens, and
a first pair of light receiving elements to receive light from the first lens;
a second unit to convert light into an electrical signal, the second unit including:
a second lens, and
a second pair of light receiving elements to receive light from the second lens,
wherein,
a profile of the second pair of light receiving elements is different in plan view than a profile of the first pair of light receiving elements.

2. The image pickup apparatus of claim 1, wherein a size of the second pair of light receiving elements is greater than a size of the first pair of light receiving elements.

3. The image pickup apparatus of claim 1, wherein a distance of the second pair of light receiving elements from an optical axis of the second lens is greater than a distance of the first pair of light receiving elements from an optical axis of the first lens.

4. An image pickup apparatus, comprising:
a first unit to convert light into an electrical signal, the first unit including (a) a first lens and (b) a first pair of light receiving elements to receive light from the first lens;
a second unit to convert light into an electrical signal, the second unit including (a) a second lens and (b) a second pair of light receiving elements to receive light from the second lens; and
a signal processing unit to process electric signals from the first pair of light receiving elements and the second pair of light receiving elements,
wherein,
a profile of the second pair of light receiving elements is different in plan view than a profile of the first pair of light receiving elements.

5. The image pickup apparatus of claim 4, wherein a size of the second pair of light receiving elements is greater than a size of the first pair of light receiving elements.

6. The image pickup apparatus of claim 4, wherein a distance of the second pair of light receiving elements from an optical axis of the second lens is greater than a distance of the first pair of light receiving elements from an optical axis of the first lens.

7. The image pickup apparatus of claim 4, further comprising an image sensor having a focus detection region, the focus detection region including the first unit and the second unit.

8. The image pickup apparatus of claim 4, wherein the signal processing unit is configured to (a) generate image data for the first unit based on the electric signals of the first pair of light receiving elements and (b) generate image data for the second unit based on the electric signals of the second pair of light receiving elements.

9. The image pickup apparatus of claim 8, further comprising a control unit configured to (a) receive image data from the signal processing unit, (b) select image data corresponding to the first unit or image data corresponding to the second unit, and (c) calculate an image interval based on the selected image data.

10. The image pickup apparatus of claim 9, further comprising an image pickup lens, wherein the control unit is configured to (a) generate a focus detection signal based on the image interval, the focus detection signal indicating whether or not a current state of the image pickup lens is in-focus, and (b) supply a signal regarding a position of the image pickup lens based on the focus detection signal if the image pickup lens is not in-focus.

11. The image pickup apparatus of claim 10, wherein the control unit is configured to (a) calculate another image interval, (b) generate another focus detection signal based on the another image interval, the another focus detection signal indicating whether or not a current state of the image pickup lens is in-focus, and (c) supply another signal regarding a position of the image pickup lens based on the another focus detection signal if the image pickup lens is not in-focus.

12. A method for controlling an image pickup apparatus, said method comprising:
receiving electric signals from a first pair of light receiving elements of an image sensor;
receiving electric signals from a second pair of light receiving elements of the image sensor; and
processing electric signals from the first pair of light receiving elements and the second pair of light receiving elements;
wherein,
a profile of the second pair of light receiving elements is different in plan view than a profile of the first pair of light receiving elements.

13. The method of claim 12, wherein a size of the second pair of light receiving elements is greater than a size of the first pair of light receiving elements.

14. The method of claim 12, wherein a distance of the second pair of light receiving elements from an optical axis of the second lens is greater than a distance of the first pair of light receiving elements from an optical axis of the first lens.

15. The method of claim 12, further comprising:
generating image data for the first unit based on the electric signals of the first pair of light receiving elements, and
generating image data for the second unit based on the electric signals of the second pair of light receiving elements.

16. The method of claim 12, further comprising:
providing the image data to a control unit, the control unit being configured to (a) receive image data from the signal processing unit, (b) select image data corresponding to the first unit or image data corresponding to the second unit, and (c) calculate an image interval based on the selected image data.

17. The method of claim 16, wherein the control unit is configured to (a) generate a focus detection signal based on the image interval, the focus detection signal indicating whether or not a current state of the image pickup lens is in-focus, and (b) supply a signal regarding a position of the image pickup lens based on the focus detection signal if the image pickup lens is not in-focus.
